(19) United States
(12) Patent Application Publication
(10) Pub. No.: US 2012/0300471 A1
(43) Pub. Date: Nov. 29, 2012

(54) Light Diffusion and Condensing Fixture

(75) Inventor: Leslie Howe, Atlanta, GA (US)

(73) Assignee: SOUTHPAC TRUST INTERNATIONAL INC., TRUSTEE OF THE LOH TRUST, Rarotonga (CK)

(21) Appl. No.: 13/531,515

(22) Filed: Jul. 23, 2012

Related U.S. Application Data
(63) Continuation-in-part of application No. 12/952,765, filed on Nov. 23, 2010.
(60) Provisional application No. 61/311,104, filed on Mar. 5, 2010.

(51) Int. Cl. F21V 5/04; F21V 17/10; F21V 13/04

(52) U.S. Cl. 362/328; 362/330; 362/433

(57) ABSTRACT

Certain embodiments may include system apparatus for providing optical film lens assemblies, light fixtures, and film tensioning frame. According to an example embodiment, a lens assembly is configured for modifying light from a light source associated with a light fixture enclosure, wherein the lens assembly is characterized by one or more optical films that are characterized by at least one or more lenticular surfaces. The lens assembly is further characterized by a curved plane. According to an example embodiment, a film-tensioning frame is characterized by a frame with four corners, wherein one or more film sheets are attached to the top or bottom of the frame at least at the four corners of the frame, and wherein the one or more film sheets are tensioned on the frame by elastic potential energy imparted into the frame before attachment of the one or more film sheets.

### RELATED APPLICATIONS

This application is a continuation-in-part of U.S. non-provisional patent application Ser. No. 12/952,765, filed Nov. 23, 2010, and claims the benefit of the following United States provisional and non-provisional patent applications, the contents of which are incorporated herein by reference in their entirety, as if set forth in full: U.S. provisional patent application Ser. No. 61/311,104, filed Mar. 5, 2010; U.S. non-provisional patent application Ser. No. 12/952,765, filed Nov. 23, 2010; and U.S. provisional patent application Ser. No. 61/575,023 entitled “Light Fixture, Retrofit and Conversion Apparatus for Recycling, Condensing and Diffusing Light,” filed Aug. 15, 2011; and U.S. provisional patent application entitled “Light Fixture, Retrofit and Conversion Apparatus for Recycling, Condensing and Diffusing Light,” Ser. No. 61/629,120 filed Nov. 14, 2011, and U.S. provisional patent application entitled “Light Fixture, Retrofit and Conversion Apparatus for Recycling, Condensing and Diffusing Light,” Ser. No. 61/630,387 filed Dec. 12, 2011; and U.S. provisional application entitled “Light Fixture, Retrofit Light Fixture, lens Assembly and Retrofit Lens Assembly” filed Jun. 19, 2012.

### TECHNICAL FIELD

This invention generally relates to lighting, and in particular, to light fixtures, lenses, lens assemblies and optical film mounting systems.

### BACKGROUND

Lighting fixtures, whether designed for commercial or residential applications, lens systems are used to control the fixture's light distribution pattern, light intensity and diffusion. Key elements for lens systems are efficiency and low manufacturing cost. There is a continuing long felt need for lens systems that can provide the required control of a light fixture's output, but do so with improved efficiency and lower manufacturing costs. These needs may be addressed by certain embodiments.

### BRIEF SUMMARY

In an example embodiment, a film-tensioning frame is characterized by a frame with four corners, wherein one or more optical film sheets are attached to the top or bottom of the frame at least at the four corners of the frame. The one or more optical film sheets are tensioned on the frame by elastic potential energy that has been imparted into the frame before the attachment of the one or more optical film sheets.

In another example embodiment, a method for tensioning one or more film sheets on a frame is provided for, the method being characterized by applying lateral force to four corners or four sides of a four cornered frame, and subsequently attaching one or more optical film sheets to the frame at least at each frame corner. When the lateral force on the frame corners or sides is removed, the optical film sheets may be evenly tensioned on the frame.

In another example embodiment, a lens assembly is configured for modifying light from a light source, and the lens assembly characterized by one or more optical films, wherein the one or more optical films are characterized by at least one or more lenticular surfaces, and wherein the lens assembly is characterized by a curved plane.

In another example embodiment, a retrofit lens assembly for attaching to a light fixture and configured for modifying light from the light fixture is provided for. The retrofit lens assembly is characterized by an optical film assembly having one or more optical films characterized by one or more lenticular lens surfaces, wherein the optical film assembly is suspended on a rigid transparent or translucent rigid or semi-rigid substrate, on a plane substantially parallel to a plane defined by the optical aperture of the light fixture.

In another example embodiment, a lens assembly configured for modifying light from a light source is proved for, wherein the lens assembly is characterized by one or more optical films characterized by at least one or more lenticular surfaces or one or more lenticular diffusion surfaces. The lens assembly is further characterized by two surfaces, wherein the axis of the plane of each surface is disposed at an angle relative to each other.

### BRIEF DESCRIPTION OF THE FIGURES

Reference will now be made to the accompanying tables and drawings, which are not necessarily drawn to scale, and wherein:

FIG. 1A depicts a perspective view of one example embodiment of a light fixture and lens assembly.

FIG. 1B depicts a perspective view of one example embodiment of a light fixture with the lens assembly separated from the fixture.

FIG. 1C depicts an exploded perspective view of an example embodiment of frame comprising window screen frame.

FIG. 1D depicts an exploded perspective view of an example embodiment of lens assembly.

FIG. 1E depicts a perspective view of the embodiment of lens assembly shown in FIG. 1D.

FIG. 2 depicts a plan view of a lens assembly inside a miter clamp jig assembly.

FIG. 3A depicts a front perspective view of an example embodiment of a light fixture and lens assembly with the lens assembly in the open position.

FIG. 3B depicts a back perspective view of an example embodiment of a light fixture and lens assembly with the lens assembly in the open position.

FIG. 3C depicts a back perspective view of an example embodiment of a light fixture and lens assembly with the lens assembly in the closed position.

FIG. 3E depicts a perspective view of example embodiment of hinge which attaches to an example embodiment of lens assembly.

FIG. 3F depicts an exploded perspective view of the example embodiment of hinge depicted in FIG. 3E.

3G depicts a perspective view of an alternate example embodiment of hinge that attaches to an example embodiment of lens assembly.

FIG. 4A depicts a perspective view of one example embodiment of a light fixture and lens assembly wherein the lens assembly nests inside the light fixture doorframe.

FIG. 4B depicts an exploded perspective view of the example embodiment of light fixture and lens assembly depicted in FIG. 4A.

FIG. 5A depicts a perspective view of one example embodiment of a light fixture and lens assembly characterized by a curved lens assembly.

FIG. 5B depicts an exploded perspective view of one example embodiment of a light fixture and lens assembly characterized by a curved lens assembly.

FIG. 5C depicts a perspective view of the curved lens assembly depicted in FIG. 5B.

FIG. 5D depicts an exploded perspective view of the curved lens assembly depicted in FIG. 5B.

FIG. 5E depicts a perspective view of the end panel of the curved lens assembly depicted in FIG. 5D.

FIG. 6 depicts a perspective view of one example embodiment of curved lens assembly comprising optical films supported on a substrate.

FIG. 7 depicts a perspective view of one example embodiment of light fixture and curved lens assembly with an LED light source.

FIG. 8 depicts a non-scale simplified diagram of light ray propagation through a curved prismatic optical film.

FIG. 9 depicts a diagram of light distribution from an example embodiment of light fixture characterized by a curved lens assembly.

FIG. 10A depicts a perspective view of an example embodiment of light fixture and lens assembly characterized by a partial elliptical hollow cylinder.

FIG. 10B depicts an exploded perspective view of the example embodiment of light fixture and lens assembly depicted in FIG. 10A.

FIG. 11A depicts a perspective view of an example embodiment of light fixture and lens assembly characterized by a partial hollow cylinder.

FIG. 11B depicts an exploded perspective view of the example embodiment of light fixture and lens assembly depicted in FIG. 11A.

FIG. 11C depicts a close-up perspective view of one end of the lens assembly depicted in FIGS. 11A and 11B.

FIG. 12A depicts a perspective view of an example embodiment of light fixture and lens assembly characterized by a lens assembly with a bi-plane aperture.

FIG. 12B depicts an exploded perspective view of an example embodiment of light fixture and lens assembly depicted in FIG. 12A.

FIG. 13 depicts an exploded perspective view of a retrofit light fixture and lens assembly.

FIG. 14 depicts a top and bottom perspective view of a retrofit lens assembly for the example embodiment of light fixture retrofit depicted in FIG. 15.

FIG. 15 depicts an exploded perspective view of a retrofit light fixture and lens assembly.

### DETAILED DESCRIPTION

Embodiments will be described more fully hereinafter with reference to the accompanying drawings, in which the embodiments are shown. This invention may, however, be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

It should be clearly understood that the embodiments of light fixture, light fixture retrofits, lenses, film assemblies, tensioning frames etc. described herein are examples, and may be adapted for use with many different designs and configurations including, but not limited to: different dimensions, different optical film configurations, different mounting configurations, different fabrication materials, different light fixture enclosures etc.

Various methods, concepts, designs, and parts may be combined to produce desired operating specifications for light fixtures, light fixture retrofits, lenses, film assemblies, tensioning frames etc., according to example embodiments, and will now be described with reference to the accompanying figures.

The term “optical film” or “film” may be used in example embodiments to apply to a single piece of optical film, or multiple pieces of optical film arranged together to form a “film stack”. The term “film assembly” may be used to apply to example embodiments of a film-tensioning frame with one or more optical films attached.

Various types and aspects of optical films that may be originally designed primarily for use with display backlight units will be subsequently briefly described, and also may have been previously described in related applications. Their configurations, photometric performance, advantages and disadvantages with respect to their utilization with example embodiments of lens assemblies and light fixtures will vary. Also, photometric requirements for different light fixtures will vary widely based on their configurations and intended applications. Accordingly, when example optical film configurations are described in example embodiments, such as the type of lenticular optical films (prismatic film or lenticular diffusion film for example), they should be construed as illustrative examples only, and should not be construed to in any way to limit the scope of possible optical film configurations. Any configuration of optical films that may be advantageous to a particular lens assembly, light fixture or lighting application thereof, may be construed to be intended in any relevant example embodiments.

For brevity, elements, principals, methods, materials or details in example embodiments that are similar to or correspond to elements, principals, methods, material or details elsewhere in other example embodiments in this application, or related applications, may or may not be repeated in whole or in part, and should be deemed to be hereby included in the applicable example embodiment.

Backlights units (BLU), as used in LCD displays for example, and in a basic form, may comprise a light source, a rear reflector, a diffuser plate disposed in front of the light source, a lenticular optical film disposed on the diffuser plate, and a diffuser film disposed on top of the lenticular film. Together, these elements may form a “light recycling cavity” or LRC.

The principles of lenticular optical films and BLUs are well known and understood to those skilled in the arts, and for brevity, they will not be discussed at length here. However, generally speaking, lenticular optical films typically have a smooth surface, and a structured surface. Off axis light incident on the smooth surface of the film may be refracted through the film, more towards the normal of the axis of the structured surface. A significant portion of light rays incident on the smooth surface of the lenticular film may be reflected backwards, becoming further scattered by subsequently multiple reflections within reflection cavity, until such time as their angles of travel allow them to refract through and lenticular film, and exiting the BLU. This recycling of light significantly increases light scattering within the BLU, and has the advantage of increased illumination uniformity across the optical aperture, and increased lamp hiding. Another advantage of BLUs is increased light output intensity due to the condensing of the light distribution pattern more towards the normal of the axis of the optical aperture.

The most common lenticular optical films for BLU's may typically be prismatic films such as 3M BEF. Prismatic films comprise rows of triangular prisms, and may be able to increase maximum light intensity in a BLU by up to 70% or more with a single sheet of prismatic lenticular film. In addition, the proportion of incident light striking the smooth surface of the film that may be recycled may be as much as 50% or more. While significant light recycling and light intensity increase are advantages in some applications, drawbacks include the need for a top and bottom diffuser to be utilized along with the prismatic film, in order to minimize the optical artifacts of the film's operation, and the requirement for a top protective surface covering the structured surface of the prismatic film. These extra film increase costs, and decrease efficiency.

Another common lenticular film used in BLUs is a lenticular diffusion film such as Kimoto Tech GM3. In a common typically used example, a lenticular diffusion film comprises a diffusion surface that includes glass beads deposited on the front structured surface, which may have the effect of diffusing light that refracts through the film, as well as condensing the light. The degree of condensation of refracted light, as well as the degree of light recycling may be both be less than that of typical prismatic films. However, two or three sheets of lenticular diffusion film may be used together to significantly increase the amount of light condensing, light recycling and diffusion. Lenticular diffusion films have advantages over prismatic films in some applications:
a) The light distribution pattern of light refracted through the film may be relatively symmetrical, which is an advantage when utilized in example embodiments.
b) The viewing angle may be wider, which may also be an advantage when utilized in example embodiments.
c) The ability to combine multiple films together to customize the viewing angle, diffusion level, and maximum light intensity increase.
d) Lower manufacturing costs due to the potential decrease in the number of films needed.
e) Higher overall optical efficiency.

BLUs may typically utilize a diffuser plate, which may function to diffuse light from the light source, as well as light reflected backwards from the lenticular film. The diffuser plate also functions as a flat rigid surface to mount optical films, which may comprise one or more lenticular films, polarizing film, diffusion film etc. Diffuser plates, may have the disadvantage of being thick, and incur a relatively large light loss due to absorption when compared to diffusive optical films; however, they may be widely used due to their function as a suitable flat rigid mounting surface for the optical films.

BLUs are utilized extensively throughout the world in displays, such as in televisions, computer displays etc., and as a result, the market for BLU optical films such as lenticular and lenticular diffusion films is very competitive, which has led to very competitively priced films.

Optical films designed for BLU's generally range in thickness between 100 um and 250 um, and are cut into sheets from roll form. Accordingly, the optical films are very flexible, and have typically required a rigid flat surface to mount to, in order to keep them flat and free from distortions.

The continuing long felt need for lens and reflector systems for lighting fixtures which can provide the required light control, but do so with improved efficiency and lower manufacturing costs may be met if some or all of the beneficial aspects of BLUs and optical films designed for BLUs as described, could be utilized in a lens system for lighting fixtures.

According to example embodiments, a light fixture lens system is provided wherein one or more optical films may be suspended and tensioned on a lightweight frame, without the use of a rigid mounting surface. Certain advantages may be achieved in example embodiment where the optical films are suspended without the use of a rigid surface or substrate, including, for example:

a) the weight of the a clear rigid substrate or panel may increase the weight of the fixture, which may increase transportation and handling costs.

b) a clear rigid substrate can decrease the light output by about 8-15% depending on its composition, due to absorption losses etc.

c) certain clear rigid substrates may be prone to cracking and breakage.

d) optical quality clear substrates may cost significantly more than certain optical films.

According to certain example embodiments, the lens system may include a tensioning frame for mounting optical films, and may be shown to exhibit the some or all of the following advantageous characteristics:

a) the ability to apply tension to the films with sufficient force and uniformity to keep the films stationary, flat, and without distortions;

b) to be rigid enough so as to not flex or bend under the force of the film tension, which may cause distortions in the films surfaces;

c) the films may be mounted to or attached to the film-tensioning apparatus such that the film is flush with the frame and so that there may be no gaps between the films and surfaces of the frame, and wherein the optical films covers the optical aperture and provides a continuous periphery defined by the frame structure, thereby preventing unwanted light leakage, and increasing the usable surface area of the optical aperture;

d) the frame and film assembly may serve as a front access panel which can be quickly and easily removed from the light fixture

f) to a have low cost of manufacture, with a minimum of tooling costs and labor requirements.

g) the optical film frame may be configured to replace a door frame assembly and lens of some light fixtures, which may save on manufacturing costs.

According to example embodiments, a lens assembly and film-tensioning frame is provided, which may provide some or all of the advantages previously described. According to the example embodiment, a frame is provided which may include frame members. Example frame members may be made from materials that include aluminum, plastic, etc. Aluminum has certain advantageous properties; it is lightweight, rigid, readily available, and easily cut to size. Frame members may comprise flat extruded material, but tubing may have the advantages of a greater strength to weight ratio, decreased material costs, and decreased manufacturing costs. Regardless of the configuration or material of the frame members, the frame members must exhibit some degree of elasticity when lateral force is applied to the frame member. In practice, most types of frame members described will exhibit sufficient elasticity to provide the needed tension to the optical films (which will be subsequently described). An example of such may be roll formed aluminum tubing, such as window screen framing, which has the advantages of a low profile, sufficient rigidity, very low cost, and easy assembly using standard window screen corner connectors.

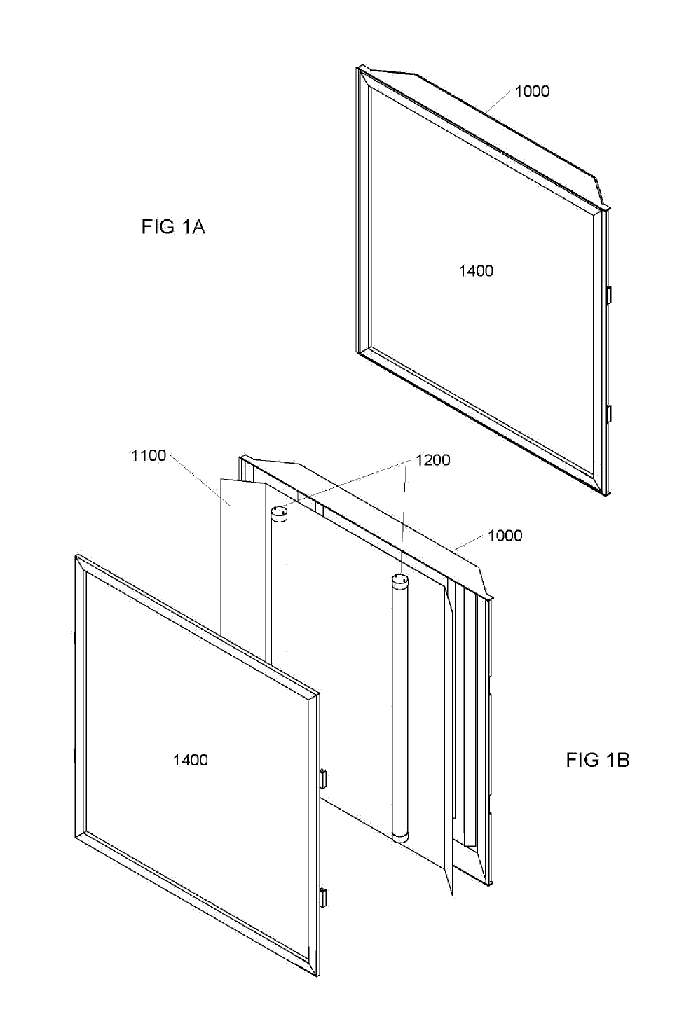

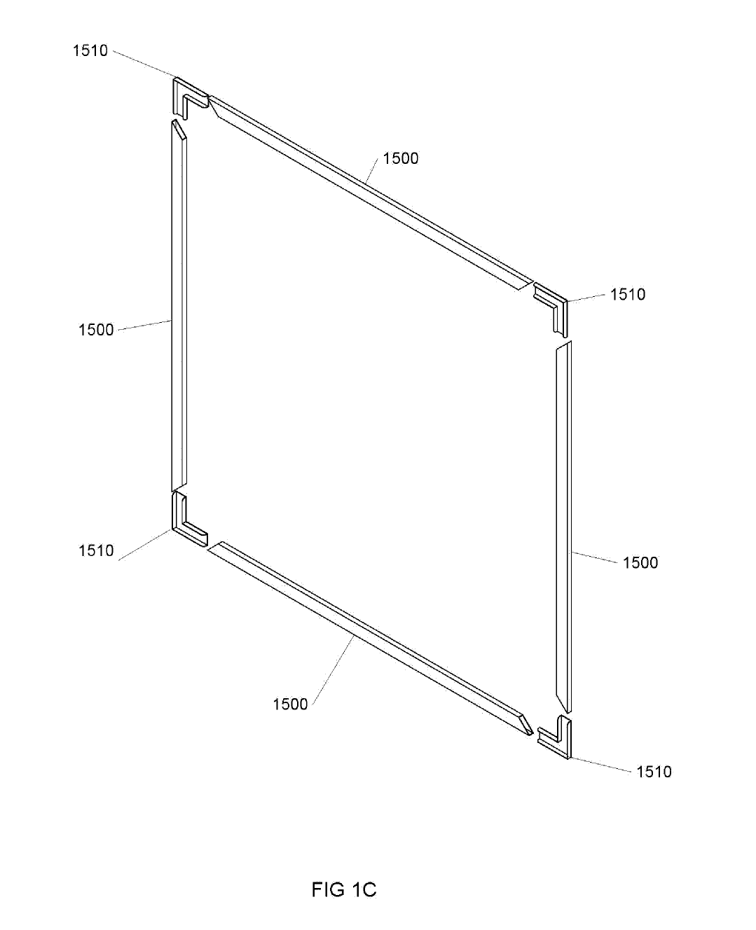

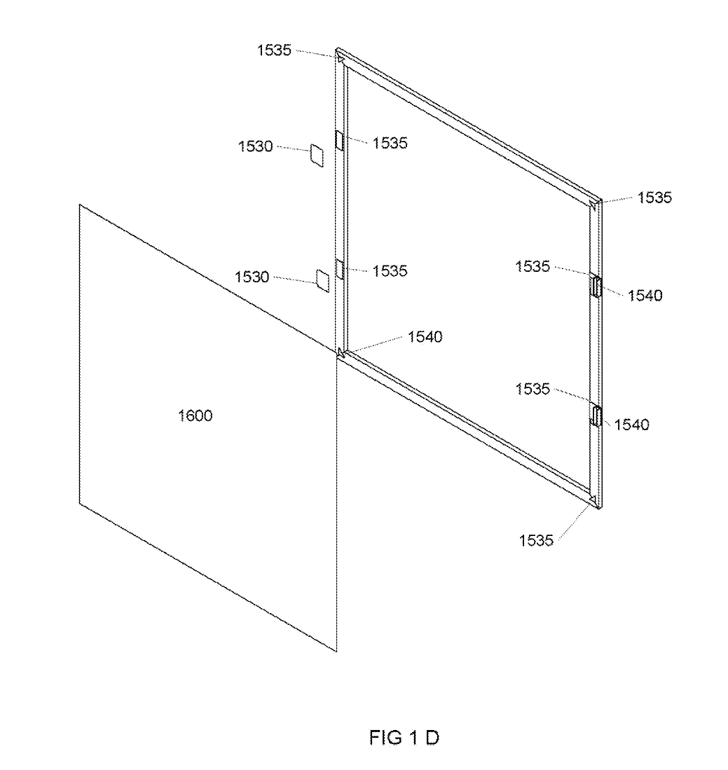

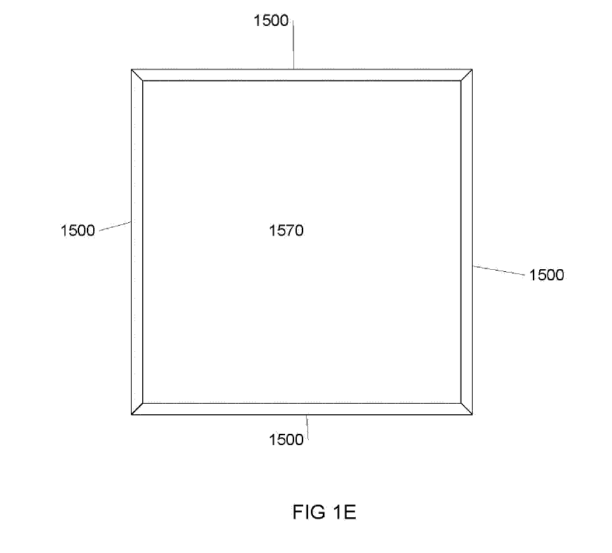

Referring to FIG. 1C, frame members 1500 may comprise standard roll formed aluminum window screen for example, and may be joined at the corners with window screen connectors, such as the example aluminum internal connectors 1510. Internal connectors may have the advantage of enabling greater rigidity in the frame, as well as enabling the frame to utilize miter cut corners, which may have a preferable visual appeal. Manufacturing costs may be reduced by the relatively quick and easy assembly requirements compared to other frame construction configurations.

This and other example embodiments can utilize screws or rivets to attach the optical film to the frame, wherein the screws or rivets protrude through holes in the optical film corners and attach to the frame member corners. Staples may also be used to attach the optical film to the frame, if the frame material is suitable to allow staples to adequately penetrate the frame members. Frame members fabricated from roll formed aluminum window screen frame may have the advantage of being able to be adequately penetrated by standard construction staples using standard staple guns, which may save on assembly time and manufacturing cost.

Alternatively, referring to FIG. 1D, the frame may be fitted in each corner with two sided adhesive transfer tape 1535, which may function to secure the optical film 1600 to the frame. Industrial strength adhesive transfer tape such as 3M VHB tape may be utilized. This method of securing the optical film to the frame has several advantages over screws, rivets staples etc.:
a) No holes need to be created in the optical film or frame members, saving on manufacturing cost.
b) With no screws or washers to insert and tighten, assembly time is reduced.
c) Self-tapping screws may not be able to be attached to frame members comprising thin material, such as window screen frame, without stripping, and may not be able to be attached with sufficient force to securely hold the optical film under tension.
d) Screws with nuts not may not be able to be utilized if it is visually unacceptable to have either end visible on the front of the frame.
e) The total surface area comprising the point of attachment between the frame member 1500 and the optical film 1600 may be greater than with a screw and washer, creating a stronger bond, and less prone to ripping or tearing the optical film.

Elastic potential energy may be imparted into the frame members before the optical films are attached by applying lateral forces to the sides or corners of the frame. It is preferable that the force is applied equally to each side of the frame or each corner of the frame. If uneven force is applied, the uneven elastic potential energy within various frame members may cause the optical film to be non-uniformly tensioned, which may cause visible distortions. Additionally, one or more frame corners may be out-of-square, causing the frame dimensions to be non-symmetrical. Lateral forces may be applied to the frame in many ways. Key criterion for the method chosen may be the speed, efficiency and cost effectiveness of the method, and the requirement to impart sufficient and even elastic potential energy into each frame member wherein the optical film is evenly and adequately tensioned, and the frame corners remain square.

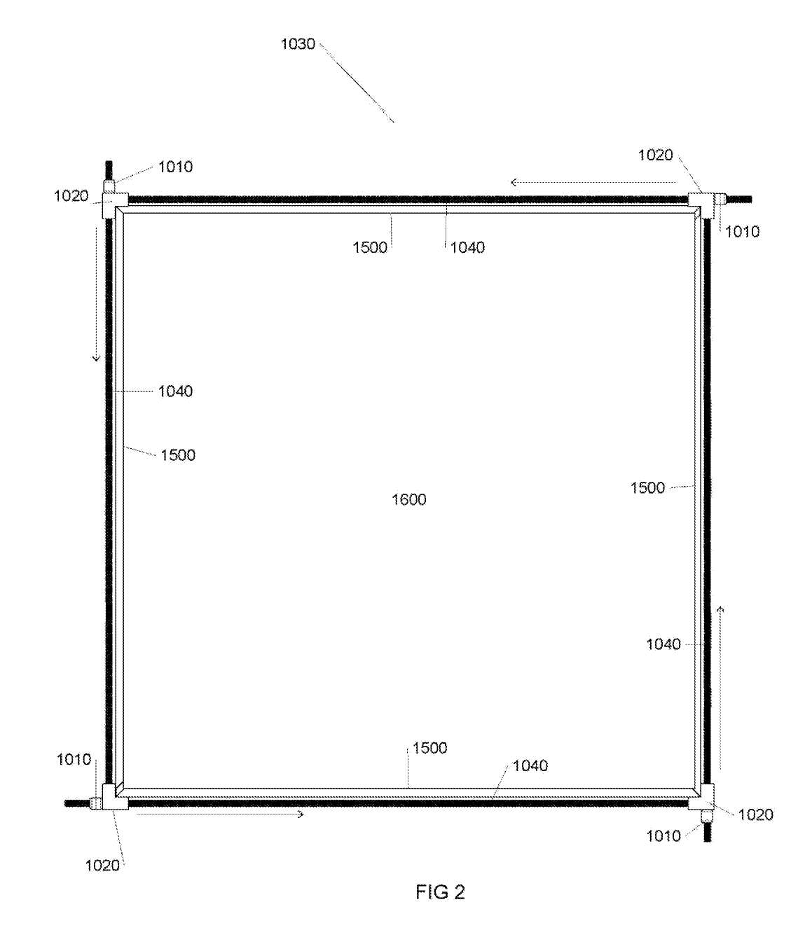

An example of a method for imparting the required elastic potential energy into the frame will now be described. The assembled frame 1570 as shown in FIG. 1E, may be inserted face down into a jig assembly as shown in FIG. 2A. The jig may be a standard miter clamp as used for assembling picture frames. Threaded rods 1040 are typically inserted into corresponding holes on corner clamps 1020. Each of the threaded thumbscrew adjusters 1010 may be selectively turned to apply compression force to the corresponding frame member. The arrows next to each adjuster 1010 indicate the direction of the force applied when the adjuster is tightened against the corner clamp 1020. Each adjuster 1010 may be tightened by the equal amounts, such that each frame member is compressed by the same amount.

Another example of a method for imparting the required elastic potential energy into the frame may be placing the frame into a jig, wherein a vice like apparatus imparts lateral force along the length of two adjacent sides of the frame, while the two opposing sides are held static and square by fixed rails or stops. Each vice may be tightened by an equal amount.

Referring to FIG. 1D, once the frame is compressed and the required elastic potential energy is imparted evenly into the frame members, optical film 1600 may be attached by one of the methods previously described. The optical film may be sized such that an even border of approximately ⅓ of the width of the frame members is left around the outside perimeter of the frame, to allow adhesive tape to subsequently be applied to the film edges to secure them to the frame members. The optical film 1600 may then be attached as follows:
a) Place the optical film 1600 face down onto the frame such that the film is centered on the frame.
b) While keeping the optical film centered on the frame, attach one of the corners of the optical film 1600 to the corresponding frame corner, by utilizing one of the attachment methods previously described.
c) On an adjacent corner, pull the optical film in the direction following the axis of the frame member between the two corners, and away from the corner already attached, making sure to keep the optical film 1600 centered on the frame. A light pulling force of sufficient force to remove any distortions may need only be applied. Attach the corner of the film to the frame.
d) On one of the two remaining corners, pull the optical film generally in the direction away, and following the axis to the diagonal corner, making sure that the triangular section of optical film bounded by the two previously attached corners, and the corner being attached, is evenly tensioned and free of distortions. A light pulling force of sufficient force to remove any distortions may need only be applied. Attach the film corner to the frame.
e) Repeat step d) with the last corner, making sure the optical film is flat, smooth and distortion free.

Referring to FIG. 2A, once the optical film 1600 is attached as described, the adjusters 1010 on the miter clamp may be loosened, and the frame removed from the jig. The elastic potential energy created in each of the frame members 1500 by the compression force of the miter clamp may now be maintained by the action of the optical film holding each of the frame corners static. The optical film 1600 may now be sufficiently tensioned on the frame such that it may lay flat, and without distortions. Due to the method described, wherein equal compression force is applied by the miter clamp to each of the frame corners, once the frame is released from the clamp, the frame corners may retain their 90-degree dimensions, enabling the tensioned frame to remain square.

More than one optical film may be tensioned on the same frame. The arranged film stack, when lying flat, may be stapled together in the corners. It may be preferable to orient the staples wherein the flat staple head will be adjacent to the frame, which may eliminate any visible gaps between the optical film and the frame caused by the staple's height. Alternatively, each optical film in the film stack may be separately secured by adhesive transfer tape as previously described.

Once attached, the edges of the optical film 1600 may be secured to the frame with one-sided adhesive tape. This may enable the edges of the optical film 1600 to lay flat on the frame without gaps, and may also function to further secure the optical film 1600 to the frame members 1500.

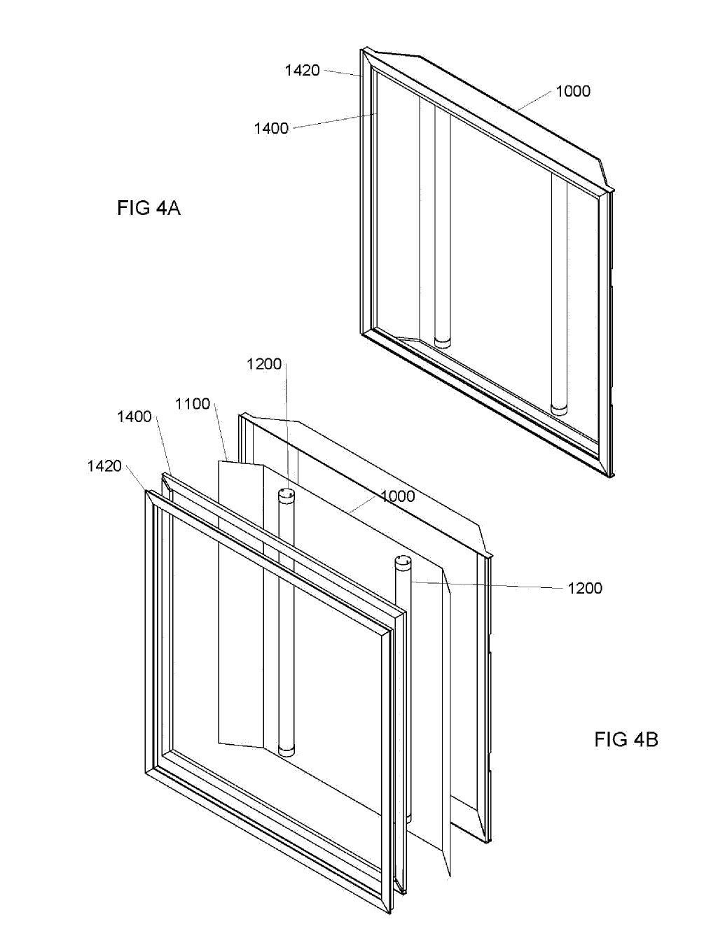

In an example embodiment, referring to FIGS. 4A and 4B, the film assembly 1400, without any hinges or latches attached, may nest inside a lighting fixture doorframe 1420 of a typical recessed lighting fixture. The doorframe 1420 may typically hold an acrylic prismatic lens. This lens may be removed, and the film assembly 1400, may be inserted in its place.

In an example embodiment, the tensioning frame with attached optical film may also simultaneously function as a doorframe on typical recessed lighting fixtures as described. This may allow significant cost saving by eliminating the need for a separate doorframe. Typical doorframes may be heavy, requiring substantially robust hinges and latches that typically require rivets or screws to secure them to the doorframe, which may increase manufacturing costs. Referring to FIG. 1D, hinges 1540 and latches 1530 may be attached onto frame members on the backside of the film-tensioning frame.

In an example embodiment, latches 1530 may be fabricated from a semi rigid flat material such as plastic or thin metal. The material must be rigid enough to support the weight of the frame, yet be flexible enough to bend sufficiently to clear the space between the tensioning frame and the adjacent lip of the light fixture enclosure 1000, when the film assembly is opened and closed. For example, PET plastic film about 250 um thick may function well for this application. The latches may be generally rectangular for example, and may be die cut. The latches may be attached to the frame members 1500 with two sided adhesive tape 1535, or with screws or rivets etc.

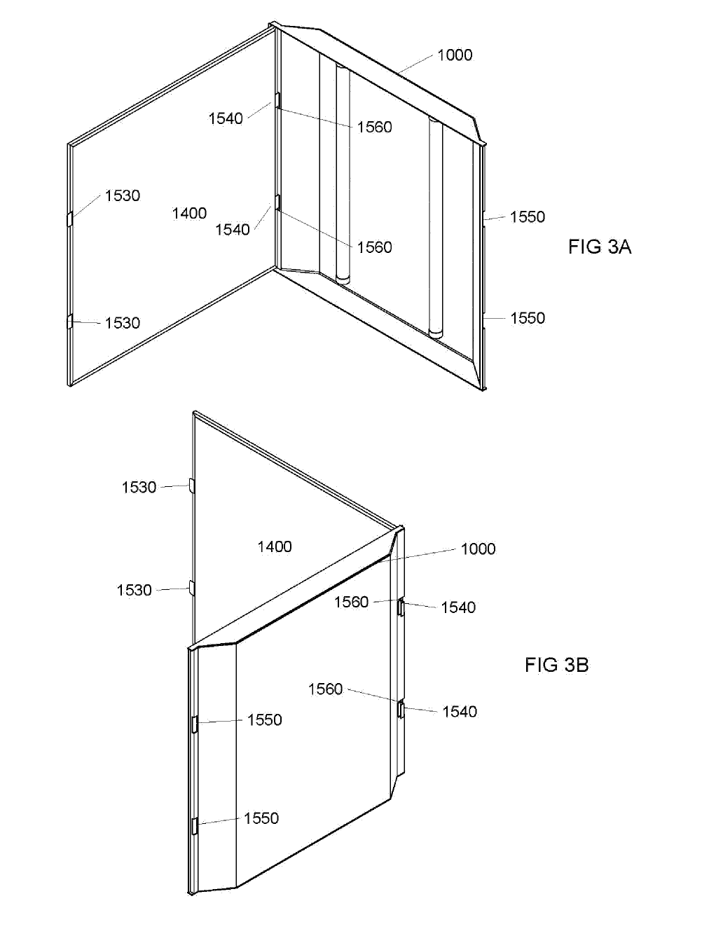

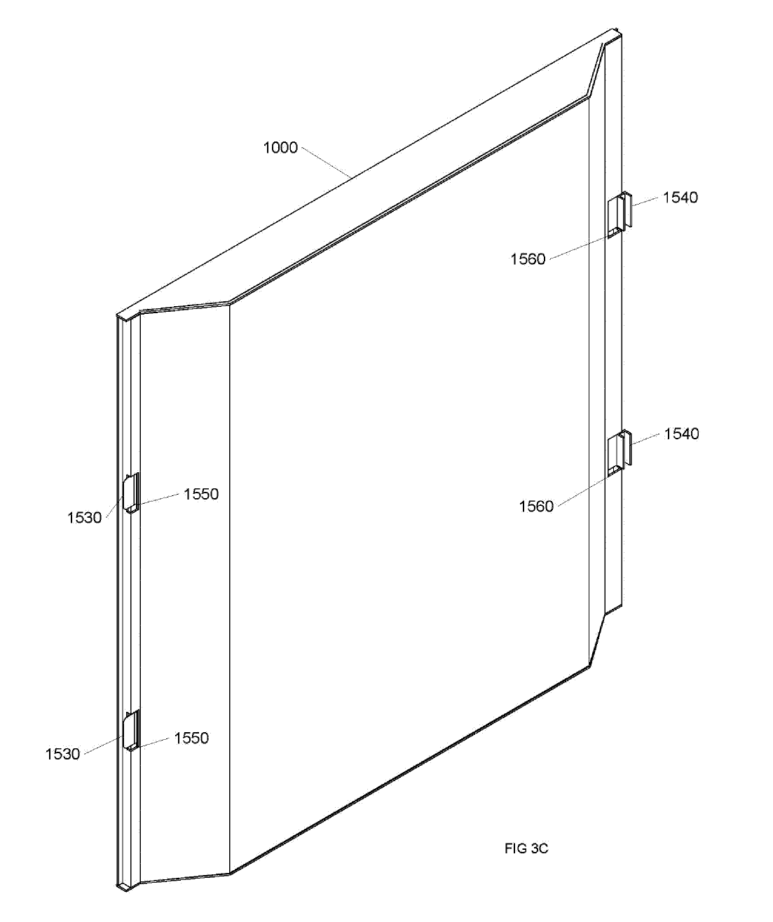

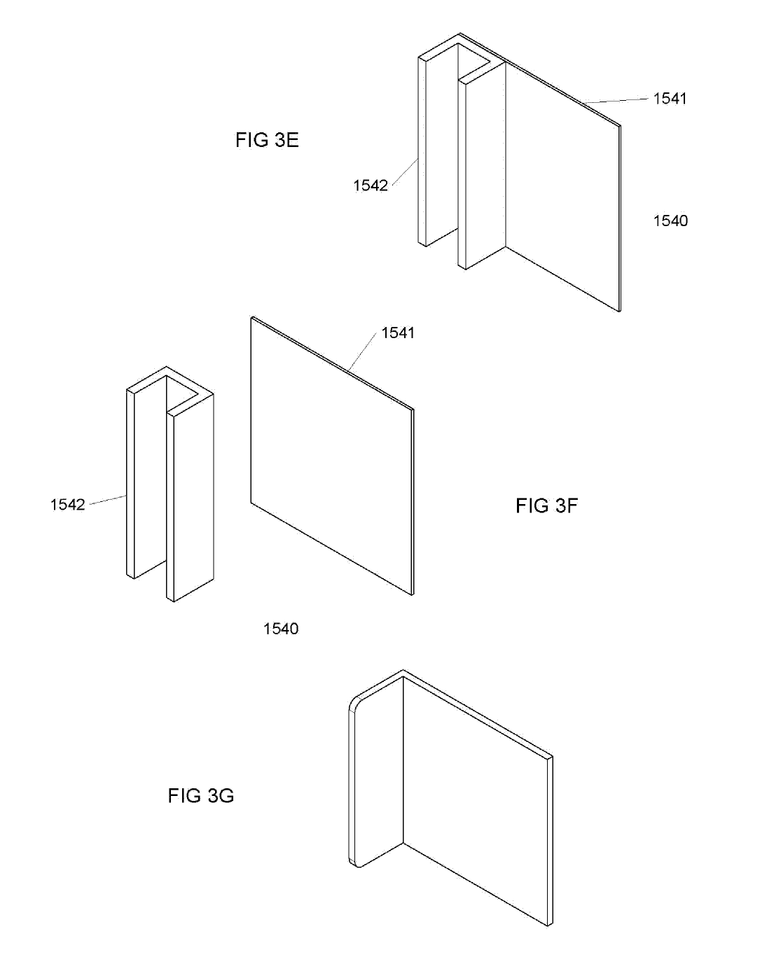

Referring to FIG. 3A where the film assembly 1400 is in the “open” position, the latches 1530 are attached to the backside of one of the frame members of the tensioning frame, and protrude beyond the edge of the frame. Referring to FIG. 3C where the film assembly is in the “closed” position, latch 1530 protrudes through slot 1550 on light fixture enclosure 1000. The slot dimensions and positioning may vary by some degree depending on the manufacturer. The fixture shown is similar to a GR8 light fixture by Cooper Lighting LLC. When the film assembly is swung into the closed position, the latches 1530 bend when they strike the front lip of the light fixture 1000, until they clear the lip. When the edge of the latches 1530 reach the slots in the fixture 1550, the stored tension in the flexed latches 1530 is released, and the latches may fully extend through the slots 1550, as shown in FIG. 3C. For the example film assembly and light fixture shown, when the front surface of the latch rests on the edge of the slot 1550, the front of the frame assembly is flush with the front of the light fixture. Other combinations of light fixtures and frame assemblies may require different latch placements, and may require the latches to be mounted on spacers, shims or in slots in order for the front of the frame to be flush with the front of the light fixture.

In an example embodiment, hinge base 1541 may be fabricated with the same material as the latches 1530, and with a similar shape. As shown in FIGS. 3E and 3F, a section of “U” shaped extrusion 1542, which may be of any suitable material, such as plastic, may be attached to the hinge base 1541. Other materials and configurations may also be used instead of the U shaped extrusion 1542 and hinge base 1541, provided the hinge comprises a substantially right-angled or U shaped rigid section which is of suitable dimensions and positioning to adequately allow the film assembly to freely swing open and closed, and to keep the film assembly firmly attached to the light fixture in the open position. For example, a one piece sheet metal or plastic hinge assembly as shown in FIG. 3G may be utilized. The extrusion may be attached with any suitable adhesive, or tape, or may it be attached with rivets or screws etc. The hinge assembly 1540 may be mounted to the frame members 1500 in a similar fashion as the latches 1530.

While holding the film assembly in a position approaching the closed position, the film assembly may be positioned such that the hinges slide into the light fixture slots FIG. 3C 1560, wherein the film assembly can then be fully seated on the light fixture enclosure 1000. For the example film assembly and light fixture shown, when the front surface of the hinges rests on the edge of the slot 1560, the front of the frame assembly is flush with the front of the light fixture. Other combinations of light fixtures and frame assemblies may require different hinge placements, and may require the hinges to be mounted on spacers, shims or in slots in order for the front of the frame to be flush with the front of the light fixture.

Referring to FIG. 3A, when the film assembly 1400 is in the open position, the front of the frame member of the film assembly 1500 on which the hinges are mounted on, may press against the lip of the light fixture enclosure 1000, forcing the edges of the extrusion on the hinge 1540 over the edge of the fixture slots 1560, enabling the film assembly to remain firmly attached to the light fixture in the open position.

Other materials other than optical films may be used with embodiments of film-tensioning frames. For example, example embodiments of tensioning frames could be used to suspend video projection screen material, other optical display surfaces, canvas for painted pictures, etc.

In accordance with example embodiments, another embodiment is presented. Certain embodiments may enable the making and using of light fixtures that may possess many features that provide certain advantages over current traditional general lighting fixtures. Embodiments of the light fixture may include one or more of the following features or characteristics:

a) to efficiently condense the beam spread of lighting fixtures and substantially increase maximum illuminance levels

b) to efficiently condense the beam spread of fluorescent lighting fixtures in two planes, and substantially increase maximum illuminance levels

c) to substantially increased maximum illuminance levels without the use of metallic specular reflectors which may cause glare and harsh light quality;

d) to control the beam spread of lighting fixtures and reduce glare without the use of grids or louvers that incur large loss of light output

e) to increase diffusion without the use of materials that incur large loss of light output

f) to enable potential energy savings by the removal of lamps from the fixture.

i) to have low manufacturing costs

FIGS. 4A and 4B depicts a perspective view of an example embodiment of light fixture or retrofitted light fixture. This example embodiment represents a simplified depiction of a traditional commercial 2′×2′ recessed fluorescent “troffer”. In the example embodiment, the light fixture may include an enclosure assembly 1000. In the example embodiment, a film assembly 1400 may be configured to suspend one or more optical films. In the example embodiment, the lens system 1400 may nest inside a lens holder frame 1420 that attaches to the enclosure assembly 1000. In the example embodiment, the lens assembly 1400 and lens holder frame 1420 may detach from the enclosure assembly 1000. Reflective insert 1100 may be attached to the inside of the enclosure 1000. Together, the combined elements may form a light recycling cavity.

Additional details and components of the light fixture or retrofit light fixture will now be discussed with reference to FIG. 4B, which depicts an exploded perspective view of the light fixture as depicted in FIG. 4A.

Common to reflectors in lighting fixtures is the use of metallic or mirrored reflecting surfaces, or white painted surfaces. Metallic or mirrored reflecting surfaces typically have a low diffuse reflectance and a high specular reflectance value. Such specular reflectors are relatively ineffective in terms of increasing light scattering within a light fixture enclosure or LRC. Therefore, light scattering within the enclosure cavity may be best served by providing reflection panels that have a high amount of diffuse reflectance to scatter the light in a more lambertian reflectance pattern. White painted surfaces provide a relatively lambertian reflectance pattern, but lack high total reflectance. According to an example embodiment, the reflection material 1100 may include a material that has high overall reflectivity of over 90%, with efficiency preferably over 95%. The reflection material 1100 for example, may also provide a diffuse reflectance of over 95%. Example materials that may provide such characteristics include foamed microcellular PET plastic sheets. Such example materials may be obtained from Kimoto Tech Inc. and include products such as the REF-WHITE series of reflector film. The reflection material 1100 may exhibit an essentially flat reflected color temperature curve throughout the visible light spectrum so that coloration is not introduced in the output light.

The reflector material 1100 may be cut into individual pieces and adhered to the corresponding surfaces of the enclosure 1000. According to other example embodiments, the reflection material 1100 may include a continuous piece of reflection material that may or may not be scored along one or more axes, and may be adhered to the inside of the enclosure with an adhesive, adhesive tape, or magnets. In an example embodiment, the reflection material 1100 may include holes and slots cut as necessary. In many retrofit applications, the reflection sheet may comprise a continuous piece of reflection material without score lines, which may be inserted between the lamps and the inside of the enclosure cavity, and may be held in place by the lamps without the use of adhesives, fasteners or tape. Small powerful and inexpensive magnets may be utilized along the perimeter of side edges of the reflection material 1100, or at other locations as needed. For applications of retrofitting fixtures on location, this method may be the most time and cost efficient.

The light fixture or retrofitted light fixture may include a lens assembly 1400 which may be substantially similar to previously described example embodiments such as the embodiment shown in FIGS. 1A and 1B, comprising a film-tensioning frame, and which may comprise one or more optical films, that may form a partially reflective and partially transmissive optical aperture from which the light may exit the light fixture. For example, the film assembly 1400 may be configured to suspend a prismatic film along with a top and bottom diffuser, or may be configured to suspend one or more lenticular diffusion films.

The original fixture depicted in FIG. 4A in this example embodiment is a recessed fluorescent troffer fixture, which utilizes four fluorescent lamps, white painted interior reflective surfaces, and an acrylic prismatic lens, which nests inside the lens holder frame 1420. It may have a wide viewing angle, and the half brightness-viewing angle may be approximately 110 degrees×100 degrees, with a gradual tapering of output levels as the exit angles increase. The retrofitted light fixture and elements thereof depicted in FIGS. 4A and 4B and described in detail, may have various performance advantages compared to the original fixture which may include:

1. The retrofitted light fixture, when utilizing the same four lamps as described, and utilizing one particular commercially available prism film along with a particular commercially available top and bottom diffuser, may condense the half brightness-viewing angle to approximately 95 degrees by 70 degrees, and with a maximum candela output increase of approximately 70%. As previously discussed, the amount of light condensing, and therefore the viewing angle and light output increase will be determined by the particular prism film, lenticular film, lenticular diffusion or diffusion films utilized.

2. Utilizing the same film components, when the two lamps located in the inside positions of the original fixture's lamp configuration are removed, the maximum candela output may be in the range of 90% to 100% of the original maximum candela output. The relative increase in output may be caused by increased efficiency with the LRC due to two less lamps (the surface areas of which decrease LRC efficiency), as well as the ballast distributing additional current or voltage to the remaining two lamps. Depending on the particular ballast/lamp arrangement, current draw may be decreased in the range of approximately 40% to 50%. This illustrates a key advantage to the example embodiment, which is maximum illuminance levels of a retrofitted fixture with two lamps can remain at a level similar to the original fixture with four lamps.

3. Due to the high degree of light scattering (the principals of which have been previously described) within the LRC, the light output from the fixture may be more diffused.

4. The light output level at angles greater than the half brightness viewing angles tapers off sharply. This sharply decreases high angle light levels, and cuts down on glare, which increases visual comfort.

5. When one or more lenticular diffusion films are utilized instead of prismatic film, the half-brightness viewing angle may be symmetrical on both the horizontal and vertical planes. The viewing angle may also be wider than may be attained with traditional prism films, and with higher overall efficiency and decreased intensity, due to decreased light recycling and condensing.

6. Despite a net decrease in output lumens from the retrofitted fixture, light from the fixture at high exit angles that would normally be directed to the uppermost quadrant of a space, may be functionally redirected towards the work plane, causing more light to be directed to where it may be of more functional use. This may effectively increase the coefficients of utilization of a light fixture. In many applications, this redistribution of light may compensate for the net loss of lumens from the fixture.

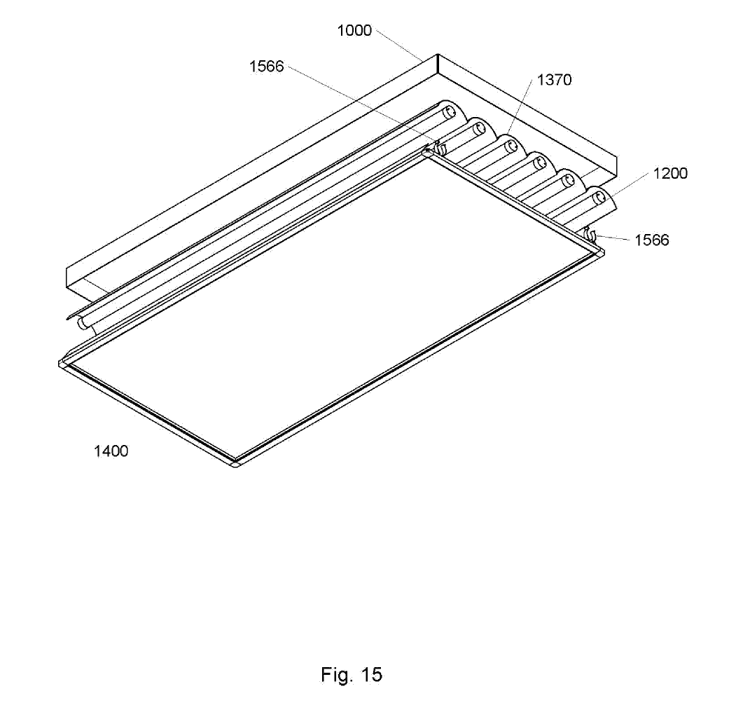

FIG. 15 depicts a perspective view of another example embodiment of retrofitted light fixture, and represents a simplified depiction of a fluorescent high bay lighting fixture that utilizes 6 fluorescent lamps. In the example embodiment, the light fixture may include an enclosure assembly 1000 and metallic reflectors 1370. In the example embodiment, a lens assembly 1400 may be substantially the same as used in a previous example embodiment, which may utilize a film-tensioning frame and optical film configurations previously described. In the example embodiment, the frame assembly 1400 may clip onto ends of two of the lamps in the fixture with four lamp holder clips 1566 mounted on the underside of each end of the frame assembly 1400. When clipped onto the lamps, the frame assembly 1400 along with the reflectors 1370 and enclosure 1000 may form a light recycling cavity.

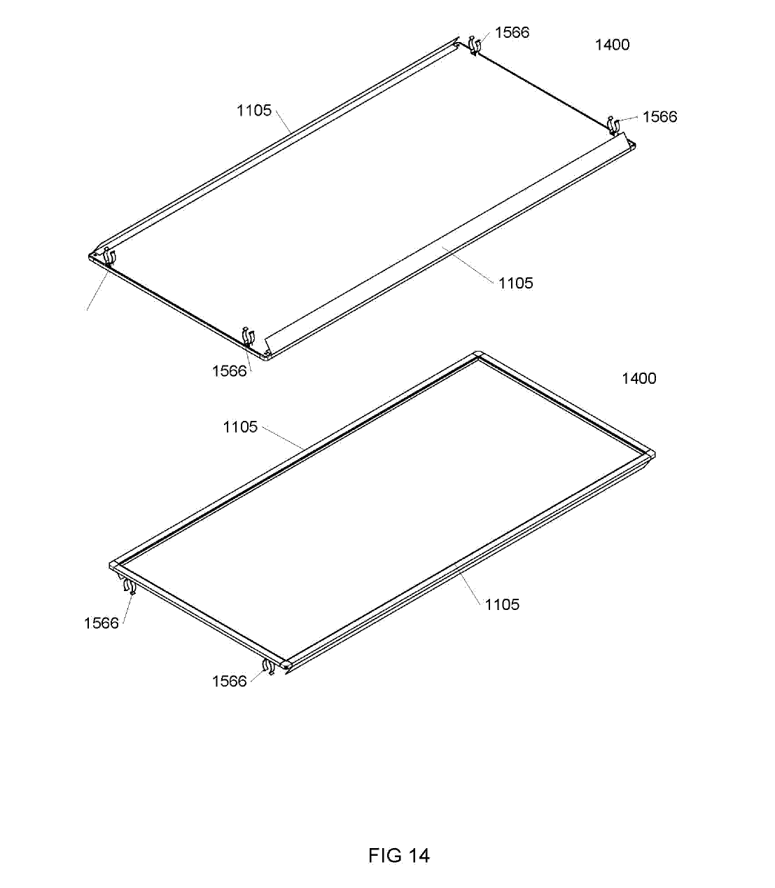

Additional details and components of the retrofit light fixture will now be discussed with reference to FIG. 14 that depicts a top and bottom perspective view of lens assembly 1400. The lamp clips 1566 may be mounted to the frame members of the lens assembly 1400 with suitable fasteners such as adhesive tape, screws, clips or rivets. The lens assembly 1400 may be sized appropriately, and the lamp clips 1566 mounted appropriately, such that each lamp clip 1566 may align with the corresponding end section of each end of both outside lamps. Adjustable brackets may also be used to mount the lamp clips to the frame members, which may allow the lamp clips 1566 to be positioned as required to align with varying lamp configurations.

Optional side reflection flaps 1105 may be disposed on both sides of the frame structure that are parallel to the lamps. They may be fashioned from the same reflection film as described previously, and may be attached to the underside of the frame structure using suitable adhesives or adhesive tape. A score line cut into the reflection film will enable the film to be precisely folded at the frame member edges, and be able to fold to the required angle. When the lens assembly 1400 is clipped onto the lamps, the free ends of the reflection flaps 1105 may be disposed inside the fixtures reflector FIG. 15 1370, causing light which would otherwise escape through the sides of the frame assembly, to be reflected back into the light fixture for subsequent recycling.

In some configurations of light fixtures designed for use on high ceilings in industrial or commercial applications where heat may be an issue, such as in this example embodiment, the reflectors of the light fixture may be configured with air ventilation holes. Although performance may be increased, the addition of a reflective film may not be practical from a heat standpoint.

The original fixture depicted in FIG. 15. It has a wide beam spread, and the half brightness-viewing angle is approximately 110 degrees×100 degrees, with a gradual tapering of output levels as the exit angles increase. The retrofitted light fixture and elements depicted in FIG. 14 and FIG. 15, may have various performance advantages from the original fixture, that may include:

1. The retrofitted light fixture, when utilizing the same six lamps as described, and utilizing one particular commercially available prism film along with a particular commercially available top and bottom diffuser, may condense the half brightness-viewing angle to approximately 95 degrees by 70 degrees, and with a maximum candela output increase of approximately 30%. As previously discussed, the amount of light condensing, and therefore the viewing angle and light output increase will be determined by the type of optical films utilized.

2. When two lamps of the retrofitted fixture are removed, the maximum candela output may be in the range of 90% to 100% of the original maximum candela output. The relative increase in output may be caused by increased efficiency within the LRC due to two less lamps (the surfaces of which decrease LRC efficiency), as well as the ballast distributing additional current or voltage to the remaining two lamps. Depending on the particular ballast/lamp arrangement, current draw may be decreased in the range of approximately 25% to 35%. This illustrates a key advantage to example embodiments, which is maximum illuminance levels of the retrofitted fixture with lamps removed can remain at a level similar to the original fixture with six lamps.

3. Due to the light scattering within the light recycling cavity, the principals of which have been previously described, the light output from the fixture is moderately diffused. Due to the specular metallic reflectors, light scattering is decreased from other embodiments.

4. The light output level at angles greater than the half brightness viewing angles tapers off sharply. This sharply decreases high angle light levels, and along with the increased diffusion, cuts down on glare and increases visual comfort.

5. Despite a net decrease in output lumens from the retrofitted fixture, light from the fixture at high exit angles that would normally be directed to the uppermost quadrant of a space, may be functionally redirected towards the work plane, causing more light to be directed to where it may be of more functional use. This may effectively increase the coefficients of utilization of a light fixture. In many applications, this redistribution of light may compensate for the net loss of lumens from the fixture.

Certain advantages of an optical film assembly that tensions and suspends one or more optical films over the optical aperture of a light fixture have been discussed in various example embodiments, as well as various example embodiments of retrofit lighting apparatuses and light fixtures described in related applications. However, advantages may be realized by utilizing the existing lens of a light fixture to support the one or more optical films. The primary advantage may be cost savings in certain applications.

For example, referring to FIG. 13, a lenticular optical film 1600A, such as a prism film for example, may be placed on top of an existing prismatic acrylic diffuser 1675 in a standard recessed troffer fluorescent commercial light fixture. The troffer may be characterized by an enclosure 1000, light sources 1200, and an acrylic prismatic diffuser lens 1675 that nests in doorframe 1420. The prismatic film may be sized to approximately the same size as the existing acrylic prismatic lens 1675, and two sided adhesive transfer tape may be adhered to various perimeter locations on the structured surface of the film. During installation, the backing of the adhesive transfer tape may be removed, and the prismatic film 1600A may be adhered to the acrylic lens back with the structured surface of the film adjacent to the back of the prismatic lens 1675. A reflective film insert 1100 may be inserted behind the lamps (as described in other example embodiments) to increase efficiency and diffusion within the LRC. The existing prismatic acrylic lens 1675 may provide enough diffusion and physical damage protection to the prism film 1600A surface such that a top and bottom diffusion film may not be required. Optional optical film 1600B may be a diffusion film, or a prismatic optical film with the alignment of prism row features disposed at 90 degrees to those of prism film 1600. Alternatively, one or more lenticular diffusion films may be utilized.

With this example embodiment, the cost of a film-tensioning frame may be eliminated, and installation costs may be significantly lower. Accordingly, a standard commercial light fixture may attain many of the advantages previously described, utilizing only a single piece of prismatic optical film, and a single piece of reflection film. Although overall performance may be somewhat diminished compared to other example embodiments, it may still provide enough advantages to justify the significant cost savings.

It may be advantageous in some applications to have a lens assembly as described in other example embodiments, which exhibits a wider light dispersion pattern, especially in applications that have low ceilings or higher ambient light requirements. It may also be advantageous in some applications to have a lens assembly as described in other example embodiments, which exhibits a higher degree of diffusion and more uniform illumination of the optical aperture. Higher diffusion and more uniform illumination of the optical aperture is especially beneficial to light fixtures with a relatively small number of light sources, small sized light sources, or widely spaced light sources, for example, a light fixture with a relatively small number of higher wattage LEDs. A high degree of lamp hiding and uniform illumination of the optical aperture may be achieved with a smaller number of light sources and with wider spacing, which may have the advantage of manufacturing cost saving and more design flexibility.

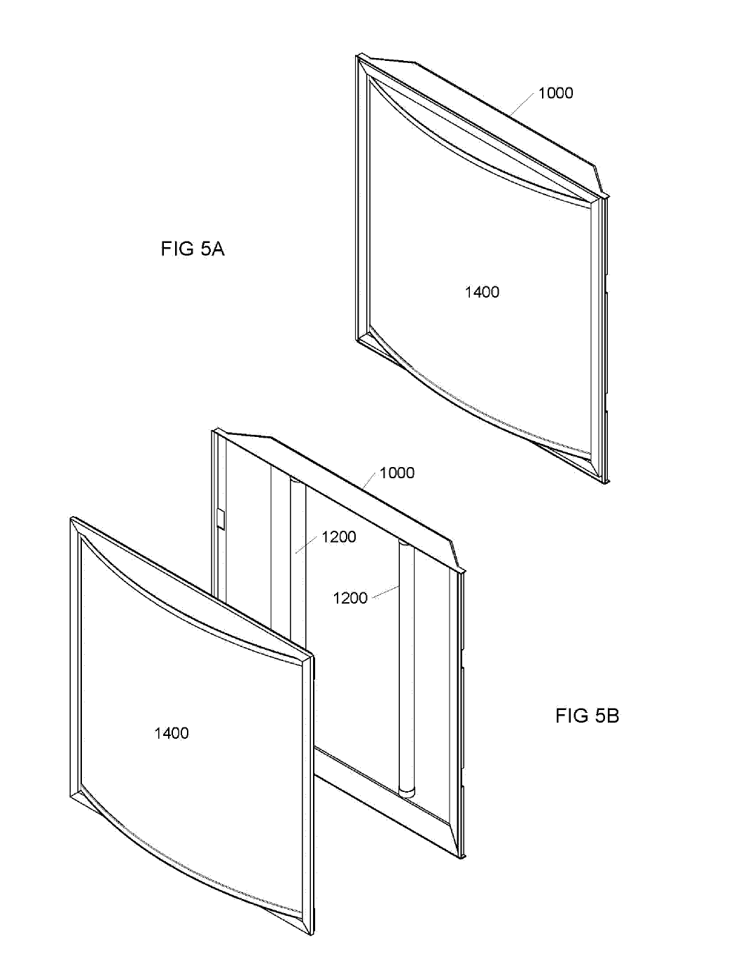

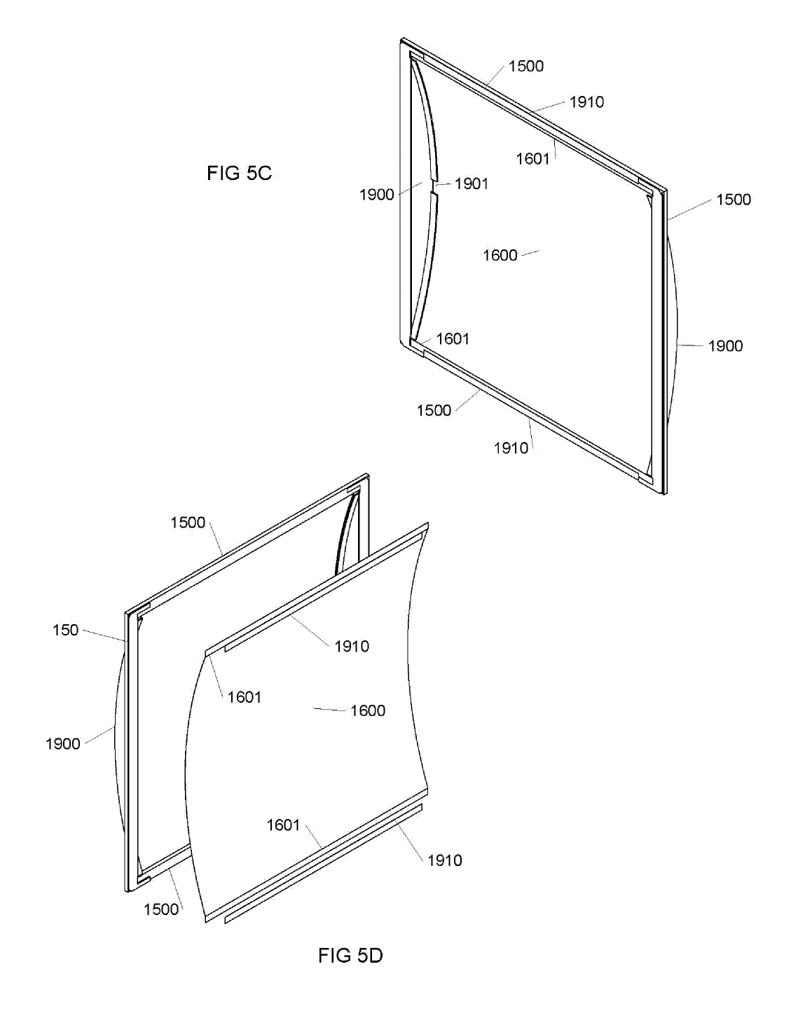

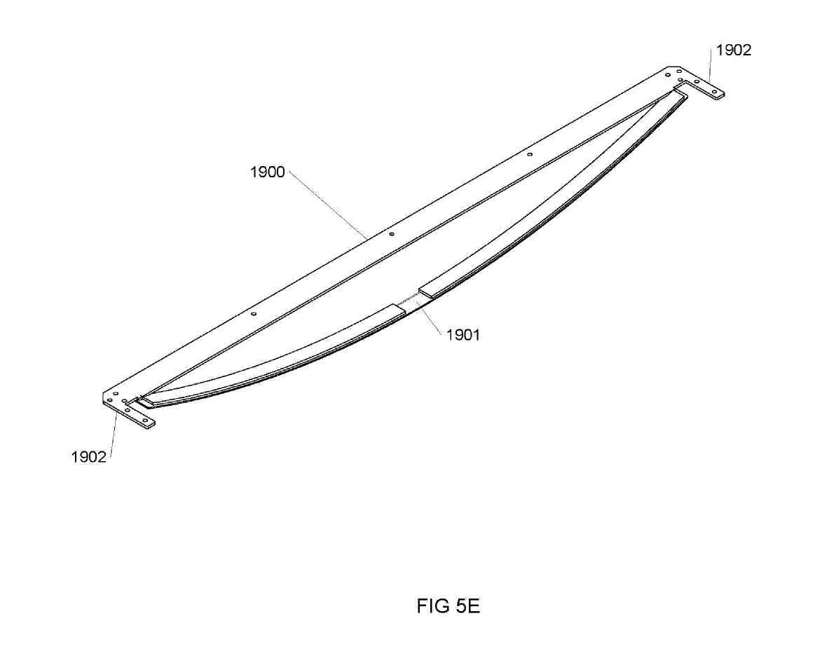

FIGS. 5A and 5B depicts a perspective view of another example embodiment of lens assembly that may exhibit a wider dispersion pattern and a higher level of diffusion, and may include an enclosure shell (1000), lamps (1200), film assembly 1400 and together may form a light recycling cavity.

An example of light fixture with a curved lens assembly similar to that shown in FIG. 5A through 5D, and with the optical film stack comprising a prismatic optical film, and a top and bottom diffuser film (as described in other example embodiments) will be used to discuss the principles of operation.

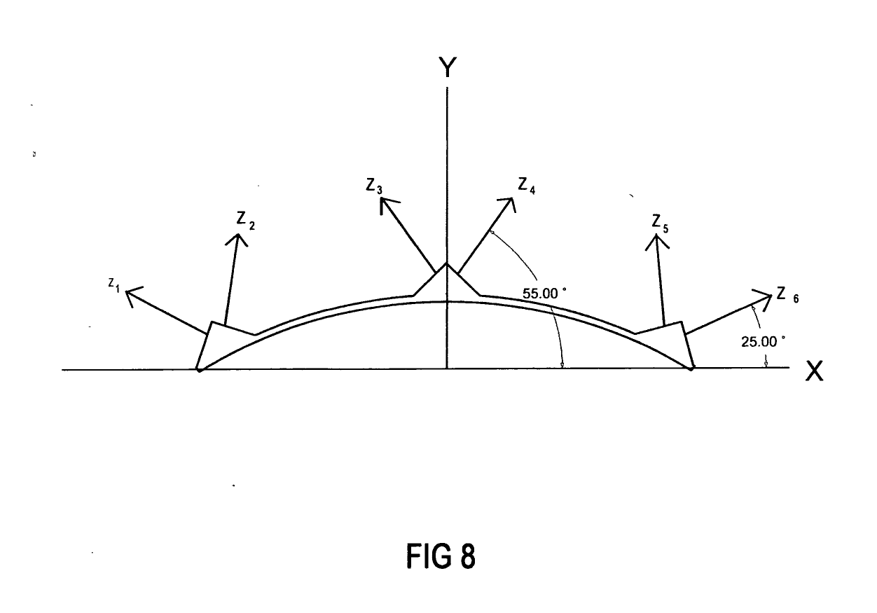

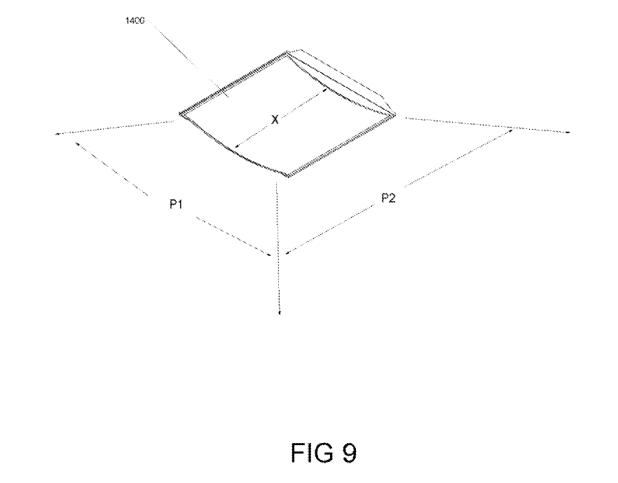

Due to the curvature of the prism film, the light distribution angles in a plane parallel to the axis of the apex of the curve will be expanded. FIG. 8 depicts a cross sectional view of a curved prism sheet. The scale, relative size of the prisms, spacing, and number of prisms are exaggerated for illustrative purposes. Z1 to Z6 represents light rays exiting the prism faces. The axis of the middle prism base may be disposed parallel to the X-axis. Light ray Z4 may exit the prism face at an angle of 55 degrees from the horizontal axis. Light ray Z6 may exit the prism on the far right side of the diagram, wherein the prism is disposed on the portion of the arc that exhibits the largest angular deviation from the horizontal axis. Light ray may Z6 exit the prism face at the same angle relative to the prism face as Z4, yet the angle relative to the horizontal axis may be 25 degrees. Light exiting the prism faces at the same relative angle as Z4 and Z6 on the prisms disposed between the right prism and the center prism (not shown) would exhibit exit angles relative to the horizontal axis that may increase from 25 degrees to 55 degrees. The net effect may be a widening of the half brightness-viewing angle along the axis of alignment of the apex of the film assembly curve. As an example, if the film assembly was mounted on the fixture similar to that depicted in FIG. 9, and the axis of alignment of the apex of the curve in the film assembly by (X), then the viewing angle would be increased in the plane as represented by (P1).

Due to the curvature of the prism film, light scattering within the LRC may be significantly increased. With an example of a flat prism film across the optical aperture (and parallel to the back surface of the light fixture enclosure), the set of “acceptance angles” of the prism film (the sets of angles of light incident at the smooth surface of the prism film that will cause the light to be either reflected or refracted), will remain relatively constant with respect to flat inner reflecting surfaces of the light fixture enclosure. In example embodiments where the bottom (incident) side of the prism film forms a curved surface across the light fixture optical aperture, the set of acceptance angles of the prism film may be distributed over a greater range of angles as compared to the angles as with the previous example of a flat prism film. This variation in angles of acceptance of the curved prism film may create a wider variation in angles of reflected and refracted light ray transmissions. Accordingly, light scattering within the light fixture may be increased, along with more variation on the exit angles of light rays exiting the output surface.

As previously described, light exiting a single flat sheet of prism film is condensed more on one plane than the other. For instance, the example prism films used in various embodiments exhibit a half brightness viewing angle of about 100 degrees×70 degrees. Accordingly, the prism film can be mounted on the film assembly such that the alignment of the prisms may be parallel or perpendicular relative to the axis of a given side of the fixture. Accordingly, the orientation of the viewing angles may be rotated by 90 degrees. Referring to FIG. 9, a fixture utilizing a curved film stack as described in this example embodiment can be configured to exhibit the most symmetrical viewing planes by orienting the prism film such that the axis of alignment of the prisms is the axis represented by line X. With this configuration, the less condensed (100 degrees) plane is represent by line P2, and the more condensed (70 degrees) plane represented by line (P1). However, the more condensed plane P1 is the plane that has the widened viewing angle due to the curved prism film. Thus, the fixture may exhibit more symmetry in viewing angles.

In example embodiments where a prism film and a linear light source are utilized, significantly more light scattering within the light fixture and significantly more uniform illumination of the output surface may be achieved by aligning the major axis of the linear light source parallel to the axis of the apex of the curvature of the film assembly, and parallel to the axis of alignment of the prisms. Referring to FIG. 9, if the axis of the light source was parallel to direction X (the axis of alignment of the prism row features), maximum light scattering may be achieved.

The viewing angle along the plane P1 (FIG. 9) can be increased or decreased by increasing or decreasing the curvature of the film stack. The maximum candela output of the fixture may decrease as the viewing angle increases. Therefore, the fixture can be configured for the application by taking into account needs for illuminance levels compared to viewing angles.

An example embodiment of a curved film assembly will now be presented. Referring to FIG. 5C, 5D, a frame (as described in the example embodiment depicted in FIG. 1C), may comprise frame members 1500 and internal corner connectors (not shown). End panels 1900, which may be fabricated with injection-molded plastic for example, may mount onto the backside of two frame members 1500 on opposite sides of the frame, such that the curved portion of the end panels 1900 protrudes through the frame assembly. The end panels 1900 may be attached to the frame members with traditional methods, but attachment utilizing adhesive or two sided adhesive transfer tape may have advantages as described in a previous example embodiment. The end panels FIG. 5E 1900, may include corner braces 1902, which may function to strengthen the corners of the frame, which may prevent any distortions of the frame. Distortions in the frame dimensions may cause distortions in the optical film. End panel 1900 may include a film channel 1901 in which the curved edges of the optical film may be supported.

Referring again to FIGS. 5C and 5D, optical film 1600 may be scored near the edges that mount to the frame members 1500, as shown by lines 1601, and subsequently folded in the direction towards the outer structured surface of the optical film 1600. It may be preferable to make the score line on the unstructured backside of the optical film 1600 wherein the score line may not be visible from the outside of the light fixture. Scoring of the optical film may have the advantages of increased rigidity along the two edges of the optical film 1600 that contain the score lines, and which may increase the structural stability of the final curved optical film, and also may function to create a more uniform curve in the optical film.

The scored optical film may inserted into one end of a film channel located on the inside of each end panel 1901, and may then be pulled through to the other side of the film channels 1901 until the score lines on the optical film 1601 align with the inner edges of the corresponding frame members. One-sided adhesive tape 1910 may be used to secure the edges of the optical film to the frame members. Other methods of attachment may also be utilized, such as rivets, for example, or the edges of the film may be clamped to the frame members 1500 with strips or extrusions that may attach to the frame members.

If more than one optical film is utilized, each film may be inserted into the film channels 1901 as described, and attached individually to the frame members 1500. It may be preferable to utilize thicker optical films of over 180 um, which may function to increase the structural stability of the film assembly's curved shape that may be less prone to distortions, and also may function to create a more uniform curve in the film assembly.

Slightly better performance of the light fixture may be obtained if the inner sides of the end panels sides 1900 (FIG. 5C) are lined with reflective film as previously described.

The optical film stack may also be tensioned over a frame, where the frame provides the desired form and curvature of the film assembly. Film tensioners and methods of tensioning optical films from other embodiments, as well as related patent applications, may be utilized to provide the required tension.

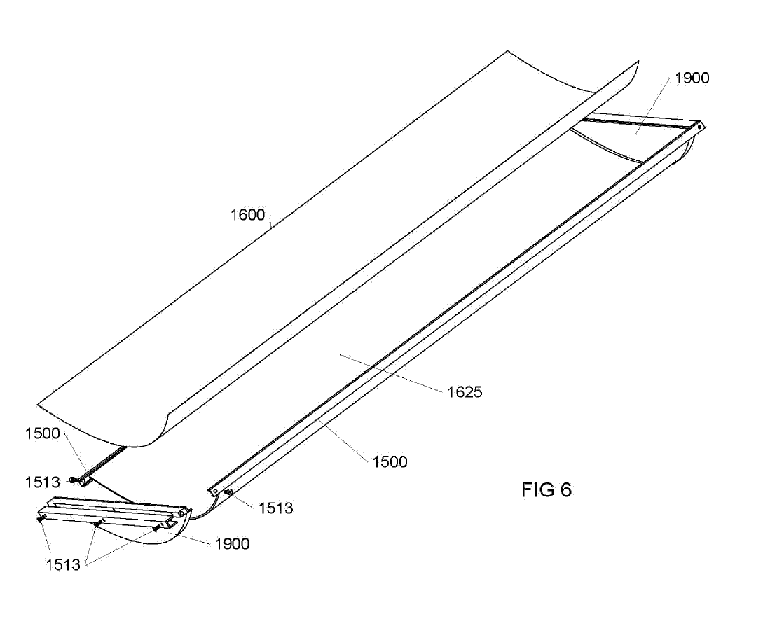

In an example embodiment, FIG. 6 depicts an lens assembly, wherein a transparent or translucent substrate may be used to support the lens assembly. Frame members 1500 may consist of “U” channel metal extrusions, such as aluminum U channel. Two end panels 1900, which may be fabricated using injection molded plastic, may nest inside two of the frame members 1500, and be secured by retaining screws 1513. The inside surface of end panels 1900 that are inside the LRC may be lined with reflection film (not shown), the type as described in other example embodiments. A transparent substrate panel of suitable dimensions 1625, which may include (but is not limited to) a panel consisting of clear or frosted acrylic, Lexan or polycarbonate, may be manually bent and inserted into the frame structure, such that two of the sides of the panel 1625 nest inside, and are held secure by the U channel frame members 1500, and wherein the curve of the panel 1625 may protrude down through the frame structure. The panel 1625 may form a suitably uniform curved substrate to support the optical film stack.

The choice of individual optical films in the optical film stack in FIG. 6 may follow the principals and selection criteria of optical films as described in other embodiments. In this example embodiment, the optical films include a single lenticular diffusion film. Thicker optical films, perhaps greater than 180 um, may be preferable, as described in other example embodiments. The films may be secured to the panel 1900 and substrate panel 1625 with adhesive tape at suitable perimeter locations.

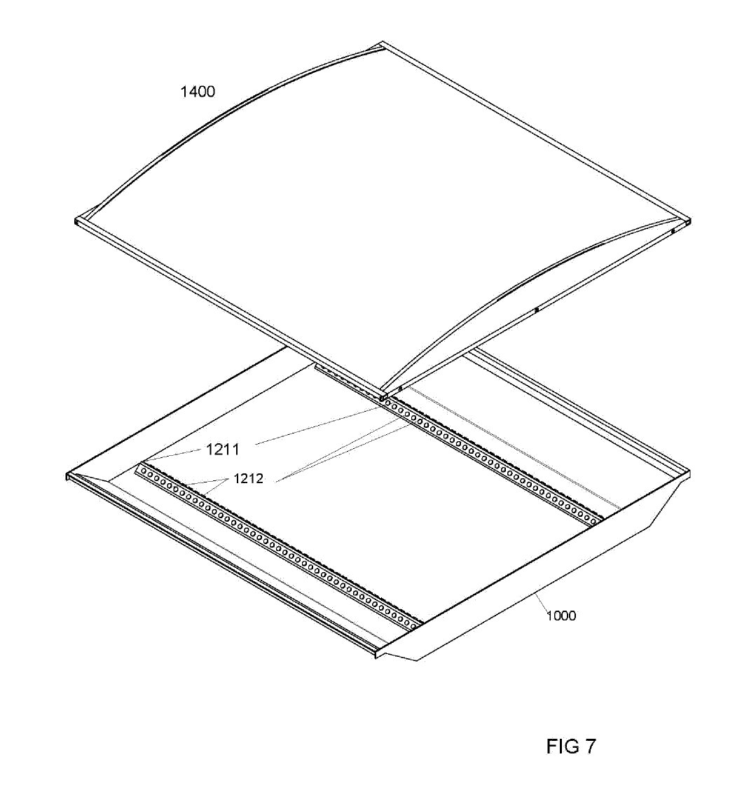

FIG. 7 shows an example embodiment that utilizes an LED light source. Light fixture enclosure 1000 has two LED mounts 1211 that may consist of 90 degree angled metal extrusions on which LED strips 1212 may be attached. Film assembly 1400 may be similar to example the embodiment described and shown in FIG. 5A through 5C, and may be mounted to the light fixture enclosure 1000. The angled LED mounts 1211 may scatter and distribute the light more evenly within the light fixture.

Another example of an advantage of LED light sources configured as described may be illustrated considering an example wherein the curved lens assembly 1400 includes a prism film. The prism film within the curved film assembly 1400 will reflect incident light rays which are close to perpendicular to the plane of the structured surface, and refract light rays that are relatively off axis. As a result, the area on the prism film output surface directly above the light source that receives direct on axis light rays from the light source may appear to exhibit shadows or uneven illumination. LEDs exhibit a dispersion pattern that is more directional in nature as compared to fluorescent lamps, which may exhibit a relatively omni-directional dispersion pattern. When LED strips 1212 are mounted on the angled LED mounts 1211, the major axis of orientation of each LED strip is disposed at 90 degrees to that of adjacent LED strips 1212, and 45 degrees to the plane that is defined by the top edges of the fixture enclosure 1000. Accordingly, a smaller proportion of light output from the LED strips 1212 is incident at the prism film in the area directly above the LED strips 1212 which, along with more uniform distribution of the light source within the light fixture, may significantly decrease or eliminate any shadows or uneven illumination on the output surface directly above the LED strips 1212.

Example embodiments of lens assembly may be characterized by one or more optical film types (as described in other example embodiments) that may be coiled to form a hollow cylinder or a hollow elliptical cylinder, or may be characterized by a partial hollow cylinder or partial hollow elliptical cylinder, wherein a light source is disposed proximate to the inside the lens assembly.

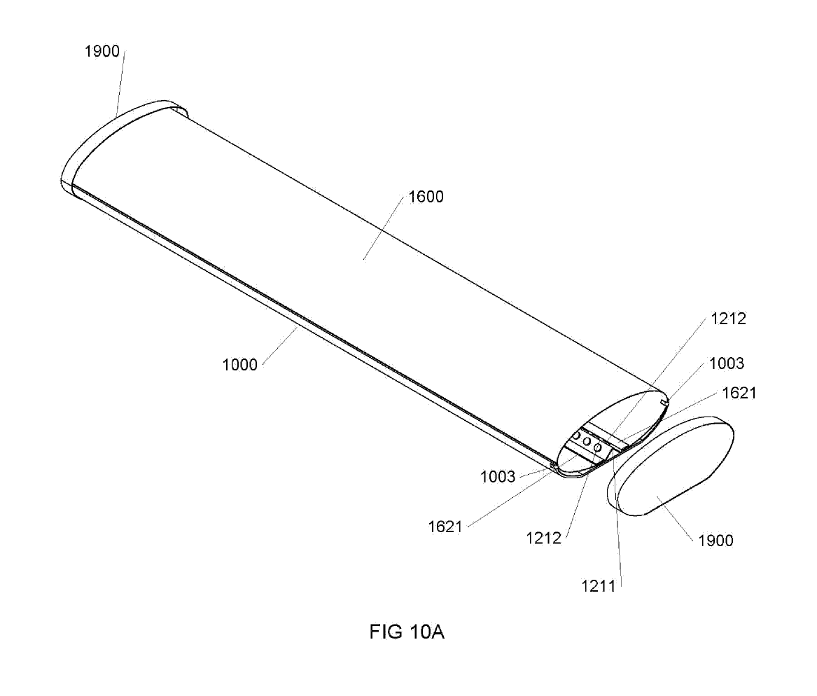

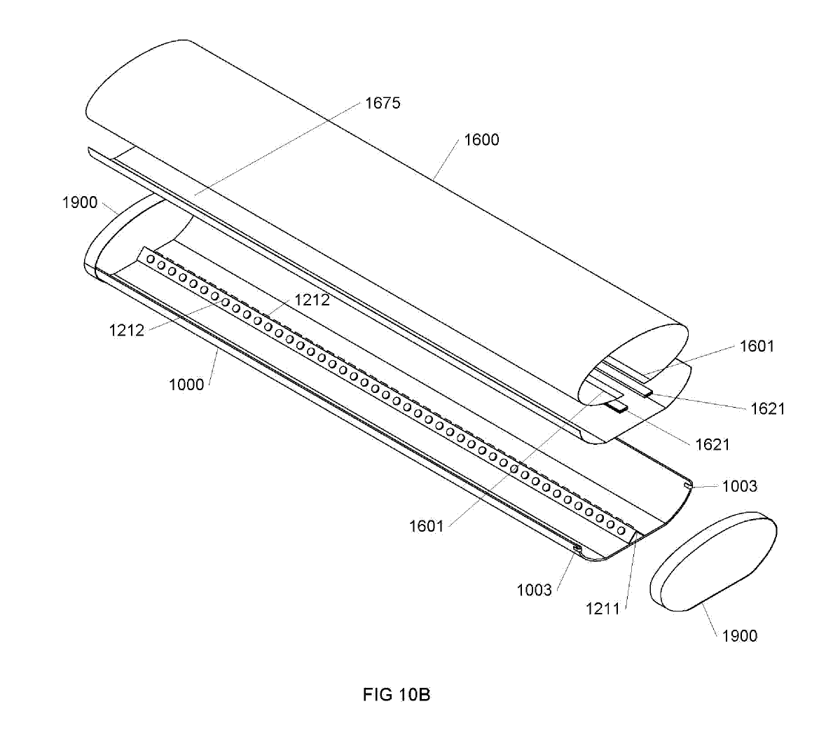

An example embodiment is shown in FIGS. 10A and 10B. The fixture enclosure base 1000 may include a light source such as an LED array (as described in other example embodiments) mounted along the center major axis. Many other suitable light sources could be used, such as linear fluorescent lamps, panel circuit board LED arrays etc. In the example shown in FIGS. 10A and 10B, the light source is similar to the example embodiment shown in FIG. 7, wherein LED strips 1212 are mounted on a right-angled extrusion 1211. Reflection film FIG. 10B 1675 may substantially cover the inside surface area of the fixture enclosure base 1000. The two non-curved edges of the one or more optical films may be scored and folded as described in a previous example embodiment, and shown by score lines 1601, which may function to increase the rigidity and stability of the lens assembly 1600. The straight edges of the optical film may be attached to any suitable linear rigid clip such as a clip strip (as described in other example embodiments), a u-shaped extrusion, or a flat and suitably rigid strip. The one or more optical films may be attached to the rigid strips with adhesive tape, screws, rivets etc., or held under spring tension by a clip strip or u-extrusion. The one or more optical films may also be stapled together along the straight edges, and secured to the light fixture with hook and loop fasteners which may be attached along the straight edges of the one or more optical films and to the fixture enclosure base (1000). The strips of optical film between the score lines and the film edges may also be inserted into slots in the light fixture enclosure 1000 (not shown) and fastened to the enclosure 1000 from underneath.

End caps 1900 may be attached to both ends of the light fixture to prevent light escaping from the fixture, to control the light distribution pattern, and to give a finished cosmetically pleasing appearance. The end caps 1900 may be lined with reflective film as described in other example embodiments. The lens assembly may be integrated into the design of a light fixture, or the lens assembly may be retrofitted into an existing light fixture.

Wherein some example embodiments may have a lens assembly which forms substantially a hollow half-circular or half-elliptical shape, the lens assembly as described in the example embodiment shown in FIGS. 10A and 10B may exhibit a hollow full or substantially full circular or elliptical shape. Due to principals described in other example embodiments, the additional area of curved lenticular surfaces and optional diffusion surfaces may cause an increase in the level of diffusion and light scattering within the lens assembly, which may cause a more uniform illumination on the outer surface of the lens assembly. Additionally, the light distribution pattern may be wider from the light fixture due to the increased angular dispersion of light from the lens assembly surface, the principals of which have been described in previous example embodiments.

The shape of the lens assembly may be controlled to a degree by lens clips 1003 that clips the lens assembly to the fixture enclosure base 1000. Moving the lens clips 1003 to positions closer to the light source 1212 may allow the lens assembly to retain a more circular shape due to the compression forces within the coiled lens assembly.

The lens assemblies described in this example embodiment may be used in a wide variety of light fixture applications, and are not restricted to the light fixture example style as described. Some of the advantages and benefits of the lens assembly described may also apply when the lens assembly is installed on surface mount fixtures, recessed fixtures, high bay and low bay style fixtures etc. A portion or all of the lens assembly may protrude outside the light fixture enclosure, or a portion or all the lens assembly may be recessed inside the light fixture enclosure.

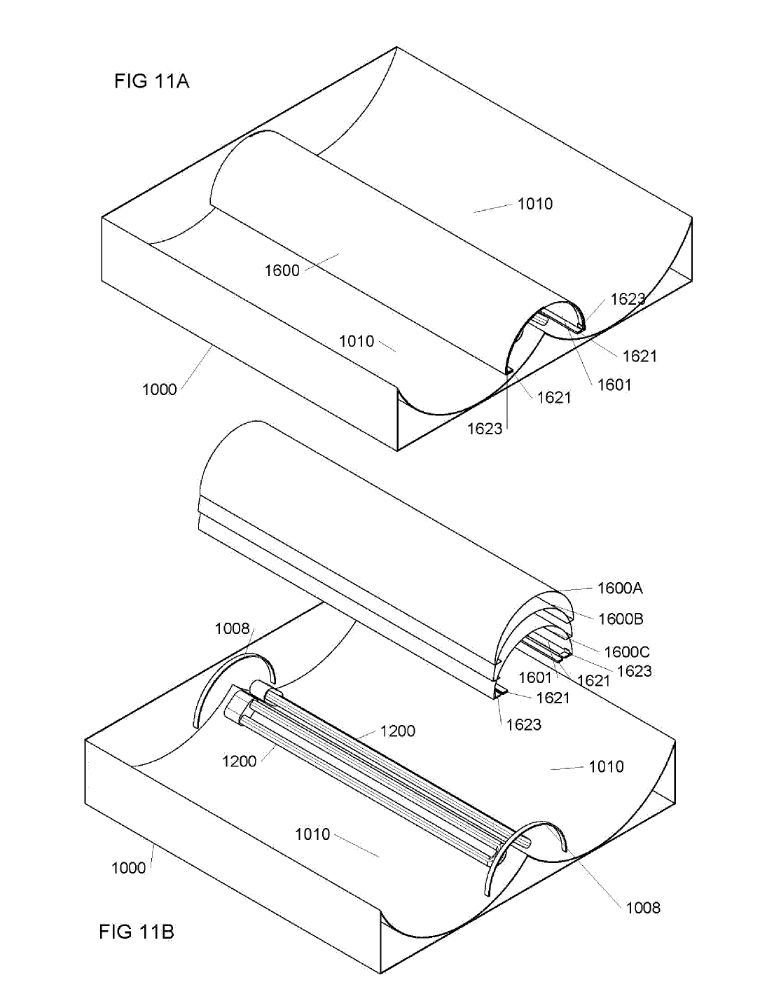

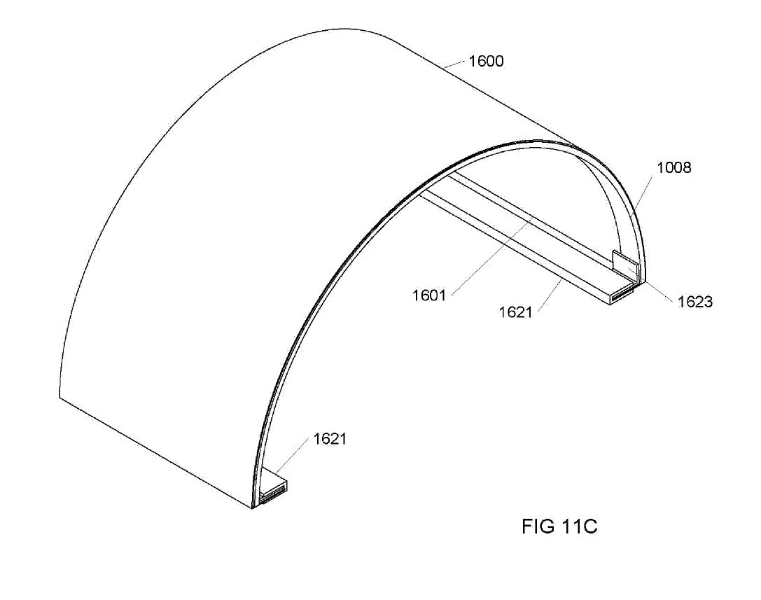

An example embodiment of light fixture, retrofit and lens is shown in FIGS. 11A and 11B. FIG. 11A shows a perspective view of the assembled light fixture with lens assembly and the fixture's end panel removed, and 11B shows an exploded view of the same. The light fixture is intended for wide-angle light distribution with a combination of direct light from the lens, and indirect light from the curved reflector panels 1010. The light fixture may exhibit a combination of refracted “direct light” exiting the lens assembly, and reflected light from the reflector.

Film assembly 1600 may be characterized by one or more optical films as described in other example embodiments, which may be coiled to form a substantially hollow half circular cylinder. In this example embodiment, the optical films may include a bottom diffusion film 1600C, a prism film 1600B and a top diffusion film 1600A. However, as previously described, the choice of particular optical films and configurations thereof may be changed to suit the application.

Optical films 1600A, 1600B and 1600C may be scored near the straight edges as shown by lines 1601 in FIGS. 11A and 11B, and subsequently folded (to an angle of about 90 degrees may be sufficient) in the direction away from the outer structured surface of the optical film. The angle of the fold should be sufficient so that the edge channel 1621 is not visible when the light fixture is viewed from any angle. It may be preferable to make the score line on the unstructured backside of the optical films wherein the score line will not be visible from the outside of the light fixture. Scoring and folding of the optical film may have the advantages of increased rigidity along the length of the optical films, and may function to create a more uniform curve in the optical film. Clear plastic edge channel 1621, may be attached to both straight edges of the multiple optical films to add additional rigidity to the lens assembly, as well as to hold multiple optical films securely together. Clip style edge channel may have the advantage of not requiring adhesives, which may lower assembly costs.

Referring FIG. 11C, which shows a close-up of one end of the film assembly, lens clips 1623 may be inserted into the edge channel 1621 at each corner. The lens clips may be fabricated from cut sections of right-angled plastic or metal extrusion, and inserted into the edge channel as shown. Adhesive may also be used to secure the lens clip 1623 in the proper position in the edge channel 1621.

When not mounted, the lens assembly may be substantially flat, with the scored film sections folded inwards at an angle. To mount the lens assembly on the fixture, starting with one corner of one end of the optical film stack 1600 in one hand, and the adjacent corner in the other hand, the space between the lens clip 1623 and the optical film stack 1600 may be placed onto the each corner of the lens-mounting ring 1008. Lens mounting ring 1008 may typically be part of, and attached to the light fixture enclosure 1000 side panels. The same procedure may be done to attach the opposite end of the film assembly to the opposite lens-mounting ring 1008. If necessary, the corners of the lens assembly may be rotated outwards to allow clearance for the lens clips 1623 to grasp the lens-mounting ring 1008.

Referring to FIGS. 11A and 11B, when mounted, a significant gap is created between the bottom edge of the lens assembly 1600 and the fixture's reflectors 1010 below it. Direct light rays from the light source 1200 that pass through this gap may be incident on the reflector 1010. A significant proportion of recycled light rays that are reflected after striking the optical films may escape through the gap and subsequently may be incident on the reflector 1010. With two lenticular films, the amount of recycled light may be significantly higher than with one lenticular film, which may cause more light to be distributed to the reflector 1010.

Due to the curvature of the reflector, light exiting the reflector may be distributed at wider angles. Accordingly, the balance of direct light from the fixture that is refracted through the lens assembly 1600, and light reflected from the reflector 1010 can be adjusted with the configuration of the optical films. This example embodiment has the advantages over traditional translucent diffusers and perforated metal baffles, of a higher degree of diffusion and lamp hiding with greater efficiency, and the ability to tailor the ratio of direct and reflected light from the fixture.

The lens assembly may be integrated into the design of a light fixture, or added to an existing light fixture as a retrofit. The lens assemblies described in this example embodiment may be used in a wide variety of light fixture applications, and are not restricted to the example light fixture style as described. Some of the advantages and benefits of the lens assembly described may also apply when the lens assembly is installed on surface mount fixtures, recessed fixtures, high bay and low bay style fixtures etc. A portion or all of the lens assembly may protrude outside the light fixture enclosure, or a portion or all the lens assembly may be recessed inside the light fixture enclosure. The lens assembly may be mounted in any fixture configuration with or without a gap between the fixture's reflecting surface and the lens assembly.

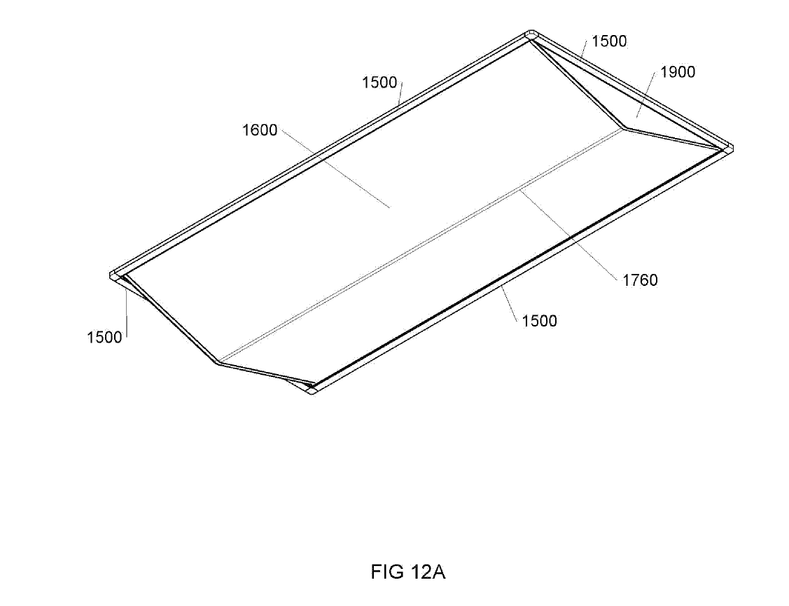

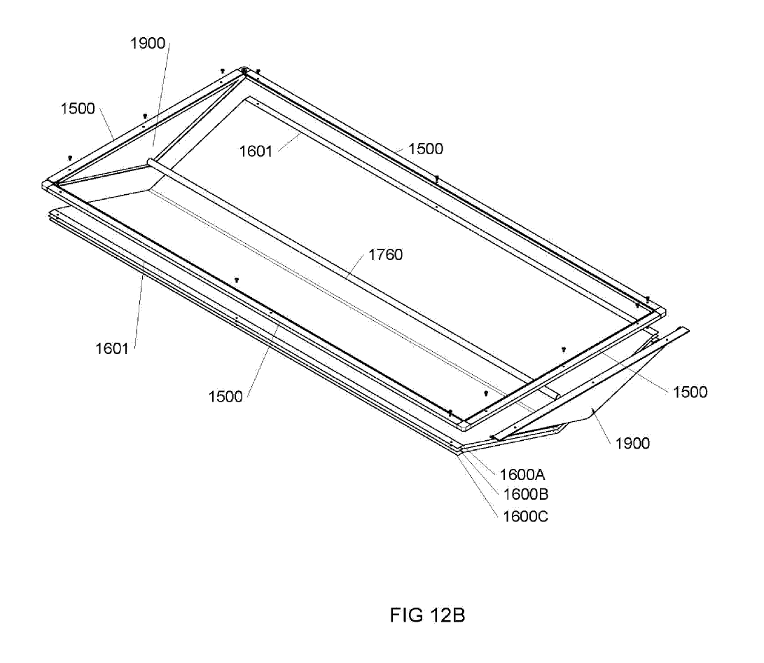

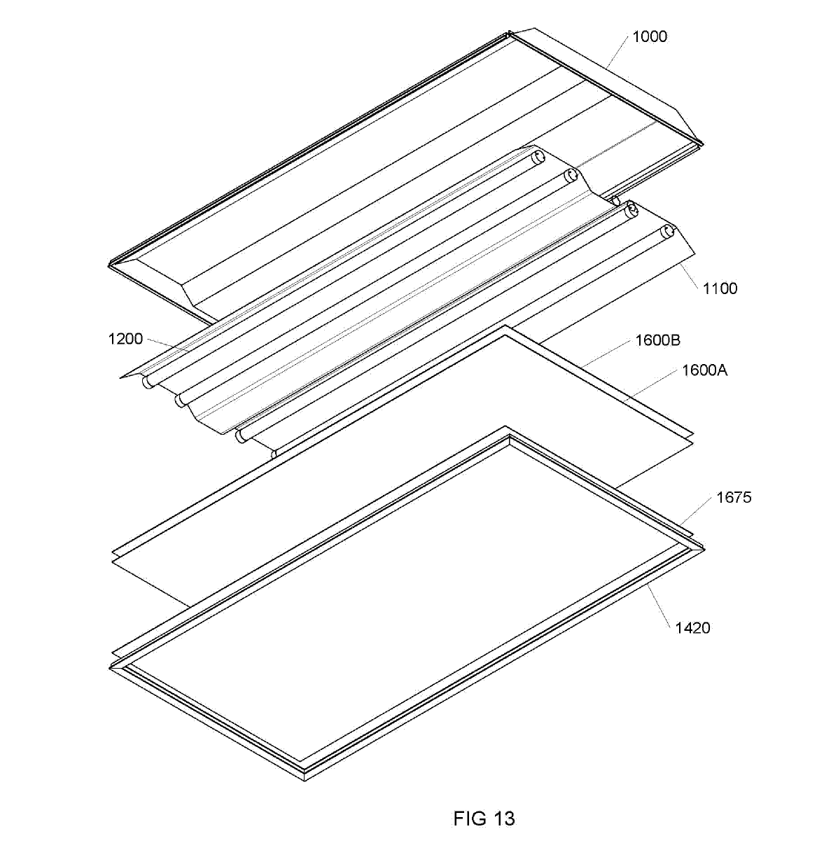

An example embodiment of lens assembly is shown in FIGS. 12A and 12B. The film assembly may be characterized by one or more optical films (as described in other example embodiments including at least one lenticular lens surface) and which may be tensioned over a support rod to form a lens assembly having substantially two planes. Referring to FIG. 12B, optical films 1600A, 1600B and 1600C may be scored near the film edges as shown by lines 1601, and subsequently folded outwards in the direction away from the inner smooth surface of the optical film. It may be preferable to make the score line on the unstructured backside of the optical films wherein the score line will not be visible from the outside of the light fixture. Scoring and folding of the optical film may have the advantages of the addition of increased rigidity along the length of the films, and may function to create a more uniform shape in the optical film assembly.

Optical films 1600A to 1600C may be fastened at their outer edges to the frame members 1500 with retaining screws as shown, which protrude through holes in the optical films. Additionally, the optical films may attach to the frame members 1500 with adhesive tape, rivets, etc. Regardless of the method of attachment of the optical film stack to the frame members, the film stack should be attached with a slight degree of tension over the support rod 1760, and the film stack should be free of any distortions.

End caps 1900 may be attached to both ends of the frame assembly to provide attachment points for the support rod 1760, to prevent light escaping from the fixture, and to give a finished cosmetically pleasing appearance. The end caps (1900) may be lined with reflective film as described in other example embodiments. Film-tensioning rod 1760 may be a standard transparent acrylic rod, or any other suitable support rod. A clear material may provide a less visible shadow when viewed from the outside of the light fixture. Each end of film-tensioning rod 1760 may be attached with screws or other suitable fasteners to each end panel 1900 near the apex of the triangular section, similar to that shown in FIG. 12B. Slots or oversized holes may be utilized in the end panels that allow movement of the film-tensioning rod at the attachment point. Once the film stack is installed and slightly tensioned as previously described, the film-tensioning rod may be manually adjusted wherein the optical film stack is sufficiently tensioned over the film tensioner rod 1760. The fasteners may then be tightened to hold the film-tensioning rod 1760 securely in place on the end panels 1900.

This example embodiment of light fixture, retrofit and lens assembly as shown in FIGS. 12A and 12B may have several advantages over other example embodiments. The two different planes of the lens assembly may add a significant increase in light diffusion and scattering within a light fixture compared to example embodiments that exhibit a lens assembly with a singular plane, the principals of which have been described previously. The increased depth of the recycling area compared to example embodiments that exhibit a lens assembly with a singular plane may also increase the diffusion and light scattering within a light fixture. Another advantage may include a wider distribution of light exiting the lens assembly, due to the increased angular projection, the principals of which have been previously described. The angles of the two planes may be configured which may enable more precise control over the angular dispersion of light from the lens assembly.

Various example embodiments of lens assemblies have been thus far presented and described. These various descriptions may include example descriptions of how the various lens assemblies are attached to, configured with, associated with, or have possible applications to example light fixture enclosures or elements thereof. For example, an embodiment of a film-tensioning frame along with various optical films has been shown to nest within a doorframe of a recessed troffer lighting fixture, as shown in FIGS. 4A and 4B. Another embodiment comprises a flexible lens assembly that clips onto a direct/indirect style lighting fixture as shown in FIGS. 11A, 11B and 11C. The light fixture enclosures or elements thereof that have been described may be generic and commercially available. However, when example embodiments of lens assemblies are attached to, configured with, or associated with these commercially available light fixture enclosures or elements thereof, they may together form a light fixture with unique and advantageous properties. Accordingly, the term “lens assembly” when used to describe an example embodiment may also be used to describe a light fixture with that example embodiment of lens assembly integrated into it.

In an example embodiment, a film-tensioning frame is characterized by frame with four corners, with one or more film sheets attached to the top or bottom of the frame at least at the four corners of the frame. The film sheets are tensioned on the frame by elastic potential energy imparted into the frame before attachment of the one or more film sheets. In an example embodiment, the film-tensioning frame of is configured to engage the one or more film sheets in a substantially flat configuration with substantially no gap disposed between the one or more film sheets and the frame. The one or more film sheets substantially covers the opening of the frame, and provides a continuous periphery defined by the frame. In an example embodiment, one or more film sheets are attached to at least the four frame corners of the film-tensioning frame with adhesive tape. In an example embodiment, one or more film sheets are attached at least to the four frame corners of the film tensioning-frame with staples. In an example embodiment, one or more film sheets are attached to at least the four frame corners of the film-tensioning frame with screws or rivets, wherein the screws or rivets protrude through holes in the one or more film sheets. In an example embodiment, the film-tensioning frame has adhesive tape applied to the perimeter intersection of the one or more film sheets and the frame members. In an example embodiment, two or more hinges and one or more latches are mounted on the film-tensioning frame, wherein the two or more hinges and the one or more latches engage in corresponding slots in a light fixture enclosure. In an example embodiment, one or more film sheets attached to the film-tensioning frame comprise optical films. In an example embodiment, the frame members of the film-tensioning frame comprise roll formed window screen frame.

In an example embodiment, a method for tensioning one or more film sheets on a frame is characterized by the application of lateral force to four corners or four sides of a four cornered frame, subsequently attaching one or more film sheets to the frame at least at each frame corner, and finally releasing the lateral force on the frame corners or sides. In an example embodiment, a miter clamp is used to apply the lateral force to the four corners of the film tensioning-frame. In an example embodiment, lateral force is applied to two adjacent sides of the frame with a vice apparatus, while the two opposing sides are held static and square.

In an example embodiment, a lens assembly is configured for modifying light from a light source which is associated with a light fixture enclosure, wherein the lens assembly is characterized by one or more optical films characterized by at least one or more lenticular surfaces, and wherein the lens assembly is further characterized by a curved plane. In an example embodiment, the curved plane of the lens assembly forms a full or partial hollow cylindrical shape or a full or partial hollow elliptical cylindrical shape. In an example embodiment, one or more optical films in the optical film assembly are suspended without the use of a support substrate. In an example embodiment, two opposing sides of the optical films are suspended between two frame members of a frame, and are attached to the frame members with adhesive tape, screws, rivets, or hook and loop fasteners. The remaining two sides of the optical films are supported along their edges by curved support structures, wherein the curved support structures are attached to the frame.

In an example embodiment, one or more optical films in the optical film assembly are supported on a curved transparent or translucent substrate. In an example embodiment, two opposing edges of the optical film assembly are held in a linear fashion, with suitably rigid strips, extrusions, clip strips, edge clips, or edge moldings. In an example embodiment, optical films from the optical film assembly are scored and folded in proximity to, and along the length of two opposing edges. In an example embodiment, the optical films from the optical film assembly are scored and folded in proximity to, and along the length of two opposing edges. The curvature of the optical film assembly is formed by laterally moving the two sides of the optical film assembly towards each other, wherein the shape of the optical film assembly is retained by attachment of the lens assembly to the light fixture enclosure. In an example embodiment, one or more optical films are characterized by at least one or more diffusion surfaces or diffusion films. In an example embodiment, one or more lenticular surfaces are characterized by triangular prisms. In an example embodiment, one or more lenticular surfaces are characterized by one or more lenticular diffusion surfaces. In an example embodiment of lens assembly, when attached to a light fixture enclosure, forms a light fixture that has a substantial portion of the lens assembly protruding past the plane that defines the optical aperture of the light fixture. In an example embodiment of lens assembly, when attached to a light fixture enclosure, forms a light fixture that has a substantial portion of the lens assembly disposed below the plane that defines the optical aperture of the light fixture. In an example embodiment of lens assembly, when attached to a light fixture enclosure, forms a light fixture wherein the lens assembly substantially covers the optical aperture of the light fixture. In an example embodiment of lens assembly, when attached to a light fixture enclosure, forms a light fixture wherein the lens assembly covers only a portion of the optical aperture of the light fixture.

In an example embodiment, a retrofit lens assembly for attaching to a light fixture is configured for modifying light from the light fixture, wherein an optical film assembly having one or more optical films is characterized by one or more lenticular surfaces, wherein the optical film assembly is supported on an existing lens surface of the light fixture. In an example embodiment, one or more lenticular surfaces are characterized by a lenticular diffusion surface. In an example embodiment, one or more lenticular surfaces are characterized by triangular prisms. In an example embodiment, the optical film assembly is further characterized by at least one diffusion surface or diffusion film. In an example embodiment, a reflective film or surface having an overall reflectivity of greater than 90% is placed between an existing reflector and the light source associated with the light fixture.

In an example embodiment, a lens assembly configured for modifying light from a light source is characterized by one or more optical films characterized by at least one or more lenticular surfaces or one or more lenticular diffusion surfaces. The lens assembly is further characterized by two surfaces, wherein the axis of the plane of each surface is disposed at an angle relative to each other.

The claimed invention is:

1. A film-tensioning frame characterized by:
A frame with four corners; and
one or more film sheets attached to the top or bottom of the frame at least at the four corners of the frame, and wherein the one or more film sheets are tensioned on the frame by elastic potential energy imparted into the frame before attachment of the one or more film sheets.

2. The film-tensioning frame of claim 1 is configured to engage the one or more film sheets in a substantially flat configuration with substantially no gap disposed between the one or more film sheets and the frame, and wherein the one or more film sheets substantially covers the opening of the frame, and provides a continuous periphery defined by the frame.

3. The film-tensioning frame of claim 1, wherein the one or more film sheets are attached to at least the four frame corners with adhesive tape.

4. The film-tensioning frame of claim 1, wherein the one or more film sheets are attached at least to the four frame corners with staples.

5. The film-tensioning frame of claim 1, wherein the one or more film sheets are attached to at least the four frame corners with screws or rivets, wherein the screws or rivets protrude through holes in the one or more film sheets.

6. The film-tensioning frame of claim 1 is further characterized by adhesive tape applied to the perimeter intersection of the one or more film sheets and frame.

7. The film-tensioning frame of claim 1 is further characterized by two or more hinges and one or more latches mounted on the film-tensioning frame, wherein the two or more hinges and the one or more latches engage in corresponding slots in a light fixture enclosure.

8. The film-tensioning frame of claim 1, wherein the one or more film sheets comprise optical films.

9. The film-tensioning frame of claim 1, wherein the frame members of the frame comprise roll formed window screen frame.

10. A method for tensioning one or more film sheets on a frame, characterized by:
applying lateral force to four corners or four sides of a four cornered frame; and
attaching one or more film sheets to the frame at least at each frame corner; and
releasing the lateral force on the frame corners or sides.

11. The method of claim 10, wherein the lateral force is applied to the frame with a miter clamp at the four corners of the frame.

12. The method of claim 10, wherein the lateral force is applied to two adjacent sides of the frame with a vice apparatus, while the two opposing sides are held static and square.

13. The method of claim 10, wherein the attachment of one or more film sheets to at least each frame corner is characterized by attachment with adhesive tape.

14. The method of claim 10, wherein the attachment of one or more film sheets to at least each frame corner is characterized by attachment with staples.

15. The method of claim 10, wherein the attachment of one or more film sheets to at least each frame corner is characterized by attachment with screws or rivets, wherein the screws or rivets protrude through holes in the one or more film sheets.

16. The method of claim 10, wherein the attachment of one or more film sheets to at least each frame corner is further characterized by the application of adhesive tape to the intersection of the film sheet and frame, after the release of the lateral force on the frame corners or sides.

17. A lens assembly configured for modifying light from a light source associated with a light fixture enclosure, wherein the lens assembly is characterized by:
One or more optical films characterized by at least one or more lenticular surfaces, wherein the lens assembly is further characterized by a curved plane.

18. The lens assembly of claim 17, wherein the curved plane of the lens assembly forms a full or partial hollow cylindrical shape or a full or partial hollow elliptical cylindrical shape.

19. The lens assembly of claim 17, wherein the at least one or more optical films in the optical film assembly are suspended without a rigid or semi-rigid substrate.

20. The lens assembly of claim 17, wherein two opposing sides of the one or more optical films are suspended between two frame members of a frame and are attached to the frame members with adhesive tape, screws, rivets, or hook and loop fasteners, and the remaining two sides of the one or more optical films are supported along their edges by curved support structures, wherein the curved support structures are attached to the frame.

21. The lens assembly of claim 17, wherein the at least one or more optical films in the optical film assembly are supported on a curved transparent or translucent substrate.

22. The lens assembly of claim 17, wherein two opposing edges of the optical film assembly are held in a linear fashion, with suitably rigid strips, extrusions, clip strips, edge clips, or edge moldings.

23. The lens assembly of claim 17, wherein the one or more optical films from the optical film assembly are scored and folded in proximity to, and along the length of two opposing edges.

24. The lens assembly of claim 17, wherein two opposing edges of the optical film assembly are held in a linear fashion with suitably rigid strips, extrusions, clip strips, edge clips, or edge moldings, and wherein the optical films from the optical film assembly are scored and folded in proximity to, and along the length of two opposing edges, and wherein the curvature of the optical film assembly is formed by laterally moving said two sides of the optical film assembly towards each other, wherein the shape of the optical film assembly is retained by attachment of the lens assembly to the light fixture enclosure.

25. The lens assembly of claim 17, wherein the at least one or more optical films is further characterized by at least one or more diffusion surfaces or diffusion films.

26. The lens assembly of claim 17, wherein the at least one or more lenticular surfaces is further characterized by triangular prisms.

27. The lens assembly of claim 17, wherein the at least one or more lenticular surfaces is characterized by one or more lenticular diffusion surfaces.

28. The lens assembly of claim 17, wherein the at least one or more lenticular surfaces is characterized by triangular prisms, and is further characterized by a first lenticular surface and a second lenticular surface disposed adjacent to one another, such that the axis of alignment of the second lenticular surface is perpendicular to the axis of alignment of the first lenticular surface.

29. The lens assembly of claim 17, when attached to the light fixture enclosure, forms a light fixture that has a substantial portion of the lens assembly protruding past the plane that defines the optical aperture of the light fixture.

30. The lens assembly of claim 17, when attached to the light fixture enclosure, forms a light fixture that has a substantial portion of the lens assembly disposed below the plane that defines the optical aperture of the light fixture.

31. The lens assembly of claim 17, when attached to the light fixture enclosure, forms a light fixture wherein the lens assembly substantially covers the optical aperture of the light fixture.

32. The lens assembly of claim 17, when attached to the light fixture enclosure, forms a light fixture wherein the lens assembly covers only a portion of the optical aperture of a light fixture.

33. A retrofit lens assembly for attaching to a light fixture and configured for modifying light from the light fixture, the retrofit lens assembly characterized by:
an optical film assembly having one or more optical films characterized by one or more lenticular surfaces, wherein the optical film assembly is supported on an existing lens surface of the light fixture.

34. The retrofit lens assembly of claim 33, wherein the one or more lenticular surfaces is characterized by a lenticular diffusion surface.

35. The retrofit lens assembly of claim 33, wherein the one or more lenticular surfaces is characterized by a prismatic optical film comprising triangular prisms.

36. The retrofit lens assembly of claim 33, wherein the optical film assembly is further characterized by at least one diffusion surface or diffusion film.

37. The retrofit lens assembly of claim 33 is further characterized by a reflective film or surface having an overall reflectivity of greater than 90%, wherein the reflective film or surface is placed between an existing reflector and the light source associated with the light fixture.

38. A lens assembly configured for modifying light from a light source, the lens assembly characterized by:
One or more optical films characterized by at least one or more lenticular surfaces or one or more lenticular diffusion surfaces; and
the lens assembly is characterized by two surfaces, wherein the axis of the plane of each surface is disposed at an angle relative to each other.
